(19) United States
(12) Patent Application Publication
(10) Pub. No.: US 2026/0067406 A1
(43) Pub. Date: Mar. 5, 2026

(54) SYNCHRONIZING AUDIO STREAMS FOR CONFERENCING ENVIRONMENTS INVOLVING MULTIPLE MICROPHONES IN PROXIMITY

(71) Applicant: Cisco Technology, Inc., San Jose, CA (US)

(72) Inventors: Piotr Bartlomiej Rozen, Gdansk (PL); Dror Eliezer Maydan, Palo Alto, CA (US); Blazej Mróz, Warszawa (PL); Marcello Caramma, Bracknell (GB)

(21) Appl. No.: 18/819,012

(22) Filed: Aug. 29, 2024

(51) Int. Cl. H04M 3/56; H04L 65/1096; H04L 65/403; H04L 65/65; H04L 65/80

(52) U.S. Cl. CPC H04M 3/568; H04L 65/1096; H04L 65/403; H04L 65/65; H04L 65/80

(57) ABSTRACT

Provided herein are techniques to facilitate synchronizing audio streams for a conference call involving multiple microphones utilized at a same location or proximity to one another. In one example, a method may include obtaining, by an aggregating node, each of an audio data stream from each of a plurality of participant devices that are proximate to each other within a conference space for a conference session in which each audio data stream obtained from each participant device comprises audio data and synchronization information, wherein the synchronization information is based on a synchronization sound broadcast during the conference session and received by each of the plurality of participant devices; and synchronizing, by the aggregating node, the audio data of each audio data stream based, at least in part, on the synchronization information included in each audio stream obtained from each of the plurality of participant devices.

### TECHNICAL FIELD

The present disclosure relates to network equipment and services for teleconferencing environments involving multiple microphones utilized in proximity to one another during a conference call.

### BACKGROUND

Conference calls enable participants or users of two or more computing devices to speak with each other from multiple locations. A conference call could have accompanied video as is common in a video conference session. The locations of the participants may be physically remote from one another. When there are two or more user devices associated with participants in a conference room location that is participating in a conference call, the management of the audio streams for the conference call can be challenging, as the voice of participants speaking in a common location might be transferred to other locations using the multiple laptops in the common location with different delays, leading to echoes, feedback loops, or choppy audio.

### BRIEF DESCRIPTION OF THE DRAWINGS

FIG. 1A is a block diagram of a system to facilitate synchronizing audio streams for a conference call involving multiple microphones utilized at the same location or proximity, according to an example embodiment.

FIG. 1B is a block diagram of an example user device that may be connected to a conference call, according to an example embodiment.

FIG. 2 is a flow chart of a method for synchronizing multiple audio streams during a conference call, according to an example embodiment.

FIG. 3A is a diagram depicting example details of an example ultrasound token format, according to an example embodiment.

FIG. 3B is a diagram depicting example details of ultrasound token broadcast schema that can be utilized during a conference call to facilitate synchronization for multiple audio streams of participant devices in proximity to one another, according to an example embodiment.

FIG. 4 is a diagram of a system and example processes to synchronize multiple audio streams of participant devices in proximity to one another to a common wall clock utilizing ultrasound tokens, according to an example embodiment.

FIG. 5 is a schematic diagram illustrating an example histogram that can be generated using histogram process for calculating a normalized timestamp difference between an audio stream of a leader participant device and a follower participant device for synchronizing the streams to a common wall clock, according to an example embodiment.

FIG. 6 is a flow chart depicting a method for synchronizing audio streams based on ultrasound synchronization events, according to an example embodiment.

FIG. 7A is a diagram illustrating example details associated with a non-ultrasound approach for synchronizing audio streams of multiple participant devices in proximity to one another during a conference call, according to an example embodiment.

FIG. 7B is a schematic diagram illustrating example sound waveform details that can be associated with the conference call, according to the example embodiment.

FIG. 7C is a schematic diagram illustrating example details for synchronizing audio streams from two participant devices, according to an example embodiment.

FIG. 8A is a block diagram illustrating details for a perceptual masking process to generate a synchronization sound waveform for use with the non-ultrasound approach for synchronizing audio streams of multiple participant devices in proximity to one another during a conference call, according to an example embodiment.

FIG. 8B is a schematic diagram illustrating example details for a loudness threshold that can be used to design a perceptual filter for use with the perceptual masking process of FIG. 8A, according to an example embodiment.

FIG. 9 is a flow chart depicting a method for synchronizing audio streams based on non-ultrasound synchronization events, according to an example embodiment.

FIG. 10 illustrates a hardware block diagram of a computing device configured to perform functions associated with operations discussed in connection with embodiments herein.

### DETAILED DESCRIPTION

### Overview

In at least one embodiment, a computer-implemented method is provided that may facilitate synchronizing audio streams for a conference call involving multiple microphones utilized at a same location or proximity to one another. In at least one embodiment, a method may include obtaining, by an aggregating node, such as a conference server or other processing device or service, each of an audio data stream from each of a plurality of participant devices that are proximate to each other within a conference space for a conference session in which each audio data stream obtained from each participant device comprises audio data and synchronization information, wherein the synchronization information is based on a synchronization sound broadcast during the conference session and received by each of the plurality of participant devices; and synchronizing, by the aggregating node, the audio data of each audio data stream based, at least in part, on the synchronization information included in each audio stream obtained from each of the plurality of participant devices.

### Example Embodiments

In dynamic/hybrid work environments, people work from offices and from home or less formal spaces like cafeterias or leased collaboration spaces, where there is no specialized equipment. Multiple users may participate in a conference call where some of the participants are located in the same room (e.g., a conference room or space where the participants are in proximity to one another) and other participants are at physically remote locations (homes, etc.). Multiple users that are in proximity to one another may each use a different device with a microphone and speaker (loudspeaker) for purposes of participating in a conference call. For example, people meeting in a conference room or other shared space frequently use their laptops for connecting to a conference call, while other people in the call (outside the room) can connect to the call from their homes.

In such scenarios, it is desirable to clearly capture and playout audio of a conference call/hybrid meeting to the meeting participants such that everyone's voice in the call can be heard. In a multi-microphone (also referred to herein as multi-mic) solution, it is possible to capture audio from multiple endpoints in the same room (e.g., participant laptops can be used to capture audio from their microphones). The audio can then be ‘combined’ in some manner and delivered to participants that are not in the room. In various instances, the combining may include dynamically switching the audio between microphones grouped in the same location or mixing the audio from the microphones in some manner.

However, potential issues with such audio combining for call participants that are in the same room or stated differently, proximate to one another, such causing a feedback loop or echo. To prevent such effects, embodiments herein introduce mechanisms that rely on a common clock among the different participant devices, often referred to as a common ‘wall’ clock. For example, in a scenario involving two participants of a meeting that are talking/listening in the same room, say Alice operating a laptop ‘A’ and Bob operating a laptop ‘B’, a conference server processing audio for the two participants can switch between the microphone of laptop ‘A’ and the microphone of laptop ‘B’ to provide audio for the room, but a common wall clock with sub-40 millisecond (ms) accuracy is needed to ensure a smooth transition between the two streams (e.g., cross-fading between the streams).

In another example, the mixing of multiple audio streams lacking a common wall clock can be difficult. For instance, mixing audio streams coming from the same room (either at the receiver or at a conference server) without appropriate synchronization can result in echoey audio. To clarify the effect of this, consider an example in which, when Alice speaks, her voice would be picked up by her microphone and Bob's microphone. When a device, such as conference server, providing audio to a remote participant, say Dave, mixes the audio from Alice and Bob, Alice's would be present voice in 2 streams, but in each stream Alice's voice will have a different delay, with a stream potentially lagging behind the other stream by several tens or even hundreds of milliseconds. Such lag can cause the mixed audio sound to become echoey.

Previous solutions typically involve systems for using only one device at a time from each location, typically a device close to the participant currently speaking. Those systems switch the selected device dynamically as different people in the room speak. In order for that switch to be seamless, it is important for devices in other locations to know the relative delay of the previously and newly selected device from the common location.

Such issues can be exacerbated when audio streams of participants in the same room are sent to a conference server over different networks and/or over different communication protocols. For example, some solutions for synchronizing wall clocks/audio streams rely on time protocols, such as Network Time Protocol (NTP) or Precision Time Protocol (PTP). However, to operate properly, NTP and PTP make one crucial assumption, that uplink and downlink network communication delays are equal. For example, NTP and PTP synchronization solutions typically utilize algorithms based on Round Trip Time (RTT), such as RTT/2, in order to estimate a common time as PTP_client_time=PTP_server_time−RTT/2 {+changes applied over time}.

PTP/NTP solutions may work well when the uplink and the downlink are symmetric but can fail if the assumption is not valid. Many communication networks can have uplink and downlink delays that are not symmetric. For example, uplink and downlink delays for mobile hotspots can differ by values greater than 100 ms (e.g. downlink delay at 20 ms and uplink delay at 130 ms). For a multi-mic environment, if another participant in the same room is using different communications links (e.g., some participants using a corporate Wi-Fi® link other participants use a Third Generation Partnership Project (3GPP) cellular link, participants utilizing links of different Wi-Fi protocols, etc.) the common time estimation among the participants can differ by more than 50 ms.

Further, different participant devices, different operating systems, etc. can use different NTP/PTP server(s) to derive their respective system times, which introduce further issues for audio stream synchronization.

Further, network synchronization solutions such as PTP/NTP can be used to estimate the time when an audio packet is enqueued by the application, but the delay from when audio is heard by a microphone until that audio is enqueued might vary significantly on different devices running different operating systems, audio drivers, and stacks.

Other solutions may seek to perform end-to-end (E2E) delay estimations using various network measurement techniques; however, such E2E delay solutions also typically assume that uplink and downlink delays are similar (which, as discussed above, is not a valid assumption), can respond slowly to changing network conditions (e.g., can be delayed at least the RTT for measurements), and may become unreliable when a participant turns off/switches their virtual private network (VPN) during a call (e.g., such an event may not cause an estimation restart, as the synchronization source (SSRC) field of a Real-time Transport Protocol (RTP) header, which is used to mark that one or more fields in the RTP header are reset, may not change).

In order to address such issues, embodiments herein provide for the ability to synchronize audio streams for a conference call involving multiple microphones being utilized at the same location or proximity, such as within a conference room. The embodiments may include broadcasting a synchronization sound (also referred to herein as a synchronization sound signal) from an audio emitting device, such as a participant device used by a conference call participant, that is at the same location or proximity with one or more other participants of the conference call such that the synchronization sound can be detected/decoded via microphones and various processing operations performed by each of the participant devices utilized at the location (including the device broadcasting the synchronization sound).

Based on detection of the synchronization sound by each of the participant devices, synchronization information can be embedded with audio data (also referred to herein as audio signal data), for example, within a header of audio data packets, streamed from each of the participant devices to an aggregating node that aggregates the streams, such as a conference server. The synchronization information embedded with the audio data can include timing information and/or other information that each participant device can determine based on detection of the synchronization sound signal.

The conference server can synchronize the audio data obtained from each of the participant devices based on the synchronization information such that the audio data obtained from the participant devices is time-aligned for further audio signal processing (e.g., selecting a stream or mixing the streams for audio playout). In some embodiments, synchronization of the multiple audio streams may include marking a Real-time Transport Protocol (RTP) timestamp for each of one or more (follower) device streams with an offset time value (+/−) that is relative to an RTP timestamp a (leader) device stream such that the audio data of the multiple streams is time-aligned for further audio processing and/or playout.

It is desirable that the synchronization sound not interfere with the actual audio content heard by participants in other locations. In some embodiments, the synchronization sound can be an ultrasound token broadcast by a device of a conference call participant. In some embodiments, the synchronization sound can be a non-ultrasound sound. In some embodiments, the non-ultrasound sound may be imperceptible or inaudible to the human car when it is broadcast. In some embodiments, such a non-ultrasound sound can be generated using a perceptual masking or filtering process to ensure that it is imperceptible/inaudible to participants of a conference call. Other synchronization sound variations are discussed for various embodiments herein.

Embodiments of the techniques proposed herein can be used when the devices of the participants connect from the same location or proximity (e.g., same conference room or space) but connect (wired and/or wirelessly) to different access points, communication networks, etc., and thus experience non-uniform networking delays such as may occur for connections to a Wi-Fi wireless local area network (WLAN), a virtual private network (VPN), 3GPP cellular network, or a fixed link.

A conference call can be a multi-party call that is a communication session between three or more participants for a period of time. Each participant may have a user device, also referred to herein as a participant device. More than one participant may be associated with or use the same device (e.g., a conference endpoint) during the conference call. The conference call has an audio component and may or may not include an associated video component, such as is the case when the conference call is a video conference call/session. A conference call can also be referred to as a conference session or meeting.

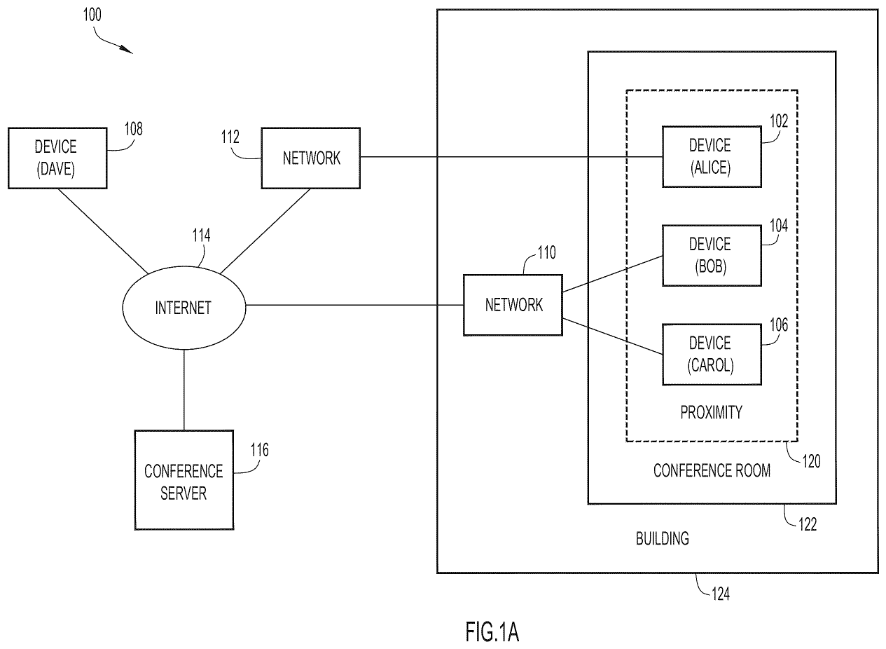

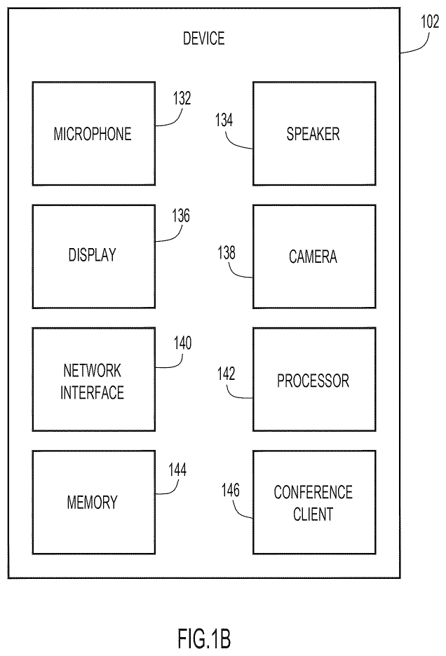

Referring to FIG. 1A, FIG. 1A is a block diagram of a system 100 to facilitate synchronization of audio streams for a conference call involving multiple microphones utilized at the same location or proximity, according to an example embodiment. In at least one embodiment, system 100 includes participant devices 102, 104, 106, and 108 that can be used by corresponding participants of a conference call, shown in FIG. 1A as, ‘Alice’ (utilizing participant device 102), ‘Bob’ (utilizing participant device 104), ‘Carol’ (utilizing participant device 106), and ‘Dave’ (utilizing participant device 108). The system 100 can also include a conference room 122 that is in a building 124, a network 110, a network 112, the Internet 114, and a conference server 116.

The participant devices 102, 104, and 106 of the system 100 can be in proximity 120 to one another. For example, the participant devices 102, 104, and 106 can be in the conference room 122 (or other physical space) in relatively close proximity with one another, e.g., with 1-5 meters between the participant devices. The conference room 122 can be located in the building 124. Although not shown in FIG. 1A, it is to be understood that other participants/participant devices could be involved in a given conference call involving participant devices 102, 104, and 106 that are not within proximity to the devices, such as within another room located within the building. Further, participant devices 102, 104, and 106 are considered not to be in the same location or proximate to participant device 108.

Participant device 102 can be connected to network 112, which is further connected to the Internet 114. Participant devices 104 and 106 can be connected to network 110, which is further connected to the Internet 114. The conference server 116 and participant device 108 can also be connected to the Internet 114. Thus, as shown in FIG. 1A, participant devices 102, 104, and 106 can be in proximity to one another but can use different networks to access the Internet 114.

Network 110 and network 112 can be any combination of wired and/or wireless communication networks, such as a 3GPP cellular network (e.g., a 3GPP 4G, 5G, 6G, etc. network), a WLAN (e.g., any variation(s) of Institute of Electrical and Electronics Engineers (IEEE) 802.11/Wi-Fi network), an Ethernet network, and/or the like. In at least one embodiment, network 110 can utilize a first communication type and network 112 can utilize a second communication type. In various embodiments, the first communication type can be different than the second communication type (e.g., Wi-Fi for the first type and cellular for the second type, Wi-Fi7 for the first type and Wi-Fi5 for the second type, etc.) or the first communication type can be the same as the second communication type).

The building 124 with the conference room 122 can be any type of room or space including, but not limited to a formal workspace environment such as a dedicated conference room, or an informal workspace environment that can include a cafeteria, a restaurant, a leased space, a huddle space, a house, a library, etc.

The conference server 116 can be a computer system that is connected to the Internet 114 and can be used to manage or control the conference call between the participant devices 102, 104, 106, and 108. The conference server 116 can also be referred to as a conference bridge server. The conference server 116 is depicted as being outside of the building 124 but can also be located in the building 124, in another building on the campus of a business or enterprise, or at any datacenter location. More than one conference server may be involved to support one or more conference calls.

In one example, the participant devices 102, 104, 106, and 108 can each determine proximity to other devices using techniques such as ultrasound proximity detection. Proximity detection can be communicated by each of the participant devices to the conference server 116. In an alternative example, conference server 116 can perform tasks such as detecting when devices are in proximity to one another. In one example, participant devices may operate in conjunction with the conference server 116 to determine proximity to other participant devices. For example, the participant devices can perform ultrasound proximity detection or can detect wireless signals and can inform the conference server 116 as to which wireless signals they detect, and the conference server 116 can ultimately determine proximity based on the information it learns from the devices.

FIG. 1B depicts an example block diagram of a participant device that may participate in a conference call, such as the participant device 102 of FIG. 1A. The components and capabilities of the device 102 described in FIG. 1B can also be applied to any of the participant devices 104, 106, and 108. The device 102 can include a microphone 132, a speaker 134, a display 136, a camera 138, a network interface 140, a processor 142, a memory 144. Further, the participant device 102 can include or be configured with a conference client 146 that may be inclusive of any combination of software, application(s), logic, etc. that enables participant device 102 to join/participate in a conference call, as well as perform any operations associated with embodiments herein. The participant device 102 can be a Smartphone, a laptop computer, a tablet computer, a desktop computer, a smart television, a smart speaker, or other electronic device with at least audio communication and network communication capabilities.

The microphone 132 can include one or more microphones associated with the participant device 102 that can be used to electronically detect sounds or sound signals (including, but not limited to, a human voice and other sounds/sound signals) for purposes of the conference call. If the participant device 102 includes multiple microphones, audio signals from the multiple microphones may be combined into one signal using beam forming. The microphone 132 can also be used to detect ultrasound emissions/signals and/or imperceptible/inaudible non-ultrasound signals that may be emitted/transmitted by other participant devices associated with a conference call. The speaker 134 can include one or more speakers to emit/transmit sound waves/sound signals associated with a conference call. The speaker 134 can be referred to as a loudspeaker. The speaker 134 can also be capable of emitting/transmitting ultrasound signals and/or imperceptible/inaudible non-ultrasound sound signals. If appropriate, the participant device 102 may include a separate microphone for ultrasound detection and a separate speaker for ultrasound emission/playout.

The display 136 can be one or more electronic displays that are capable of displaying information. The display 136 can display text, images and video associated with a conference call. The display 136 can be a touchscreen and can be capable of serving a graphical user interface (GUI). The camera 138 can refer to one or more cameras associated with the participant device 102 that are capable of capturing video and images for a conference call. The network interface 140 can be a (wired and/or wireless) network interface card capable of communicating with other devices over a network (e.g., any of network 110, network 112, and/or the Internet 128). The processor 142 and the memory 144 can be processors and memory associated with computing devices. It should be appreciated that each of the microphone 132, the speaker 134, the display 136, and the camera 138 may be integrated into a housing with the device 102 or may be external to the participant device 102 and connected by wire or wirelessly to the participant device 102.

With reference to FIGS. 1A and 1B, the system 100 may be used to implement the techniques of the present embodiments for a conference call that involves participant devices 102, 104, 106, and 108. For example, before and during a conference call, the present embodiments can determine if two or more participant devices are in proximity to one another and, for two or more participant devices that are in proximity to one another can enable synchronization of audio streams for the participant device to a common wall clock by the conference server 116. In at least one embodiment, ultrasound emissions and detections can be employed to determine if at least two participant devices are in proximity to one another. For example, each of the participant devices 102, 104, 106, and 108 can be triggered, via their respective conference clients, to emit an ultrasound signal upon joining the conference call.

With reference to participant devices 102, 104, and 106, participant device 104 can detect an ultrasound signal emitted by participant device 102 and communicate the detection to other participant devices, such as participant device 106, as well as the conference server 116. Each of the participant devices 102, 104, and 106, and/or the conference server 116 can then determine that devices are in proximity to one another. If the participant device 102 emits the ultrasound signal and the participant devices 104 and 106 do not detect the ultrasound signal then a determination can be made that the participant devices 102, 104, and 106 are not in proximity to one another. For example, participant device 108 can emit an ultrasound signal, but it would not be heard/detected by any of participant devices 102, 104, and 106. Thus, it could be determined that participant device 108 is not proximate to or is remote from participant devices 102, 104, and 106.

An ultrasound emission may not be audible to the human ear but can be detected by another participant device. Ultrasound emissions can also be reflected off and absorbed by walls which prevents proximity detection of a participant device that is not in the same room as the device emitting the ultrasound. For example, the ultrasound emissions or signals can be at 18-19 khz. Ultrasound emissions and detections can be employed to initially determine if participant devices are in proximity to one another and can be used throughout the conference call to determine if the participant devices are still in proximity to one another or if a new device has entered into proximity.

In at least one embodiment, ultrasound emissions and detections may employ Ramalho-Zilovic Spread Spectrum (RZSS) techniques. An RZSS library allows encoding of any bytes of data in an ultrasound emission that is played by a speaker of a participant device and decoded at a device receiving the ultrasound emission. In one embodiment, an ultrasound emission can take approximately 500 milliseconds to transfer one 64-bit token with 49-bits of data and 15 bits of control information using RZSS techniques. The sent data packet can include a unique device identifier (token) periodically generated by a server, such as the conference server 116, and assigned to a device, such as the device 102.

For participant devices to distinguish tokens, the tokens are to be unique for an active meeting pool and the participant devices associated with the meeting to determine if an emitting endpoint is on the same conference call. In one example, the token is created by a server, such as the conference server 116, and the server holds information about token-meeting relations. In another example, a token is generated locally based on a unique participant ID known to all devices associated with meeting participants. This technique can be called Contributing Source Identifier (CSI).

In another embodiment, the token can be generated by a given participant device itself, based on a unique identifier associated with the device.

As discussed in further detail herein, in at least one embodiment, a leader participant device selected for the conference call among the participant devices 102, 104, and 106 determined to be proximate to one another can include in a generated token an 8-bit sequence number that can be incremented between values 0 and 255 for each transmission of the token. An Internet Protocol (IP) address of the sender can be set to an IP version 4 (IPv4) address of ‘0.0.0.0’ (zero) for the token such that the token can be used to group the participant devices together as being proximate to one another and can be used to facilitate synchronization of audio streams of the devices to a common wall clock.

With RZSS, a participant device may not be detected until the whole ultrasound emission has been transmitted and decoded. In one embodiment, after the initial determination is made that two or more devices are in proximity to one another, ultrasound emission detections can be accomplished in short time frames to ascertain that the two or more devices are still likely in proximity to one another. In one example, the participant device 102 can be determined to be in proximity 120 to the devices 104 and 106 conference call using ultrasound emissions and detections. The devices 102, 104, and 106 may then be paired together in an audio group by the conference server 116.

Detection of RSZZ emissions can be accomplished using two different mechanisms. The first mechanism can be a full-fledged RZSS decoder that may take an emitted token and then provide the exact content of the message. The second mechanism can be a low latency ultrasound detector that is able to determine that there is some token being broadcasted with 30-50 millisecond latency. The techniques presented herein may use both mechanisms in combination with one another.

In one embodiment, a user interface on a participant device associated with the conference call can be used by a participant to manually join or leave the audio group. Therefore, a participant can manually choose to leave the audio group when walking out of a room or to join an audio group when walking into a room. In at least one embodiment, upon joining the audio group, either manually or automatically, a speaker associated with the participant device may be inhibited. Upon leaving an audio group, either manually or automatically, a speaker associated with the participant device may be enabled. One or more speakers can be selected using different techniques. In one embodiment, muting speakers of participant devices in an audio group may be transparent to the participants associated with the participant devices. In other words, a user interface may not indicate to the participants which speaker(s) have been selected and which and speakers(s) have been inhibited. In one embodiment, a participant may be able to manually select which speaker are selected for the audio group and which speakers(s) are inhibited. In this example, the participant may be able to manually switch which speaker are selected for the audio group.

Any device in an audio group can be selected to have their speaker uninhibited with other devices being selected to have their loudspeakers inhibited. It should be appreciated that in the embodiments presented herein, a system may have multiple audio groups associated with the same conference call where each audio group can have participant devices that are in proximity to one another, and each audio group can have a leader device with follower devices. In other words, there can be multiple groups, each group in a corresponding huddle or conference room. The conference server 116 may make one selection (for loudspeaker sound) per conference/huddle room.

The conference server 116 can track each of the audio groups with an identity of each leader and follower devices, meaning that the conference server 116 can track the roles that the devices have chosen to take. The process of leader selection can be distributed or centralized. In the former, participant devices 102, 104, and 106 can execute a leader election protocol at the end of which one leader emerges, while in the latter, the leader can be delegated by the conference server 116 (e.g., based on which participant device joins the conference call first, etc.).

Different approaches are provided through embodiments herein to facilitate synchronizing the of audio streams associated with participant devices 102, 104, and 106 (sent to the conference server 116) that are determined to be in proximity 120 to one another for the conference call (are grouped together in an audio group) to a common wall clock.

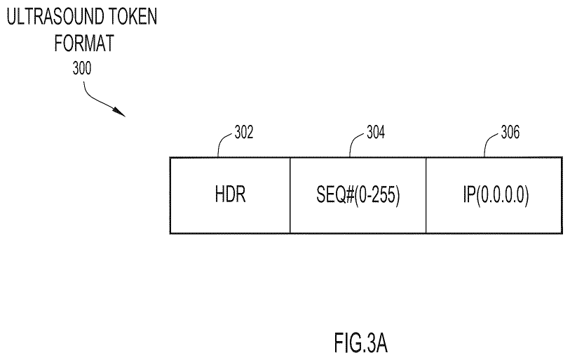

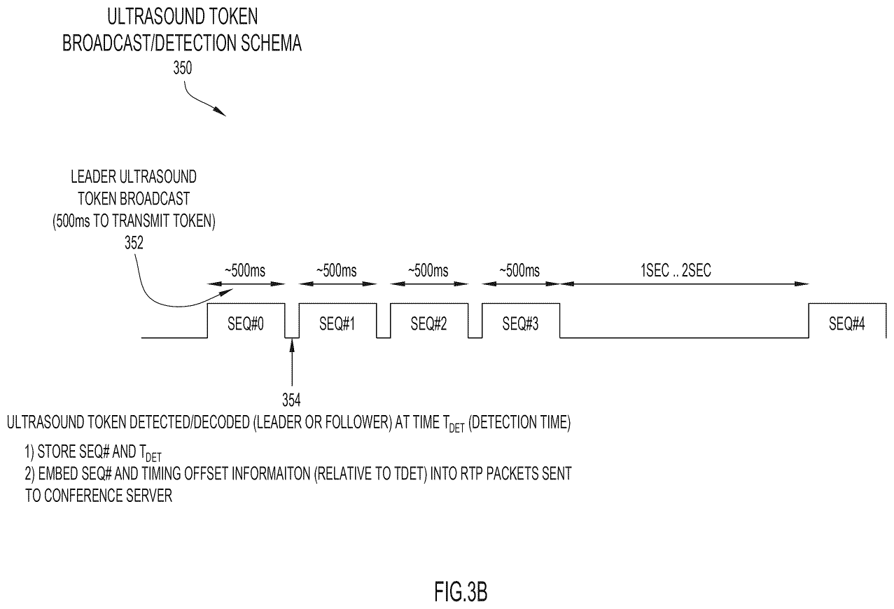

In one approach, ultrasound token emissions can be broadcast by the leader of the audio group in which the ultrasound token emissions, generally referred to as ultrasound tokens or beacons, can be detected and decoded by the leader device and each of the follower device (e.g., via their respective microphones) that are proximate to one another in the shared conference room 122 (e.g., all of participant devices 102, 104, and 106). Based on detection of the ultrasound tokens by the leader/follower devices, synchronization information can be embedded in packets of audio data streamed to the conference server 116 in which the synchronization information enables the conference server to synchronize the audio data streams of the multiple devices to a common wall clock. In at least one embodiment, the ultrasound tokens broadcast by the leader device may be RZSS tokens including a sequence number (SEQ #) and IP address of the sender set (e.g., the leader device broadcasting the tokens) to ‘0.0.0.0’ (zero). The ultrasound token can broadly be referred to herein as a ‘synchronization sound signal’ broadcast by the leader device. This approach is referred to herein as the ‘ultrasound approach’ for synchronizing audio streams of participant devices in proximity to one another during a conference call to a common wall clock. FIGS. 3A, 3B, 4, 5, and 6 discussed below provide various example details associated with an ultrasound approach for synchronizing audio streams of participant devices in proximity to one another to a common wall clock.

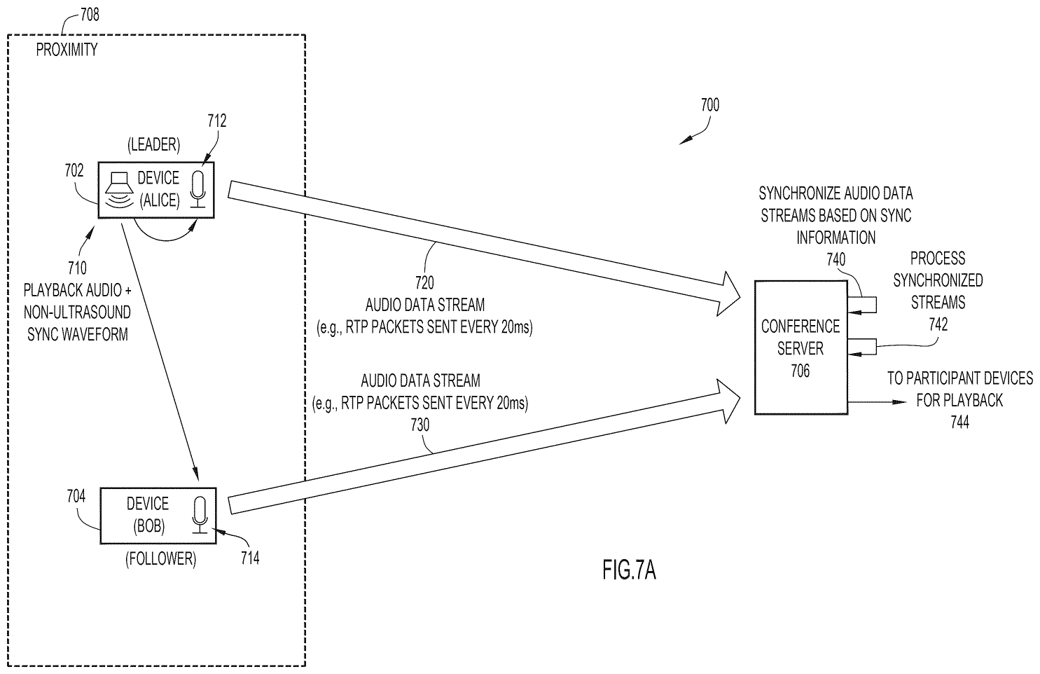

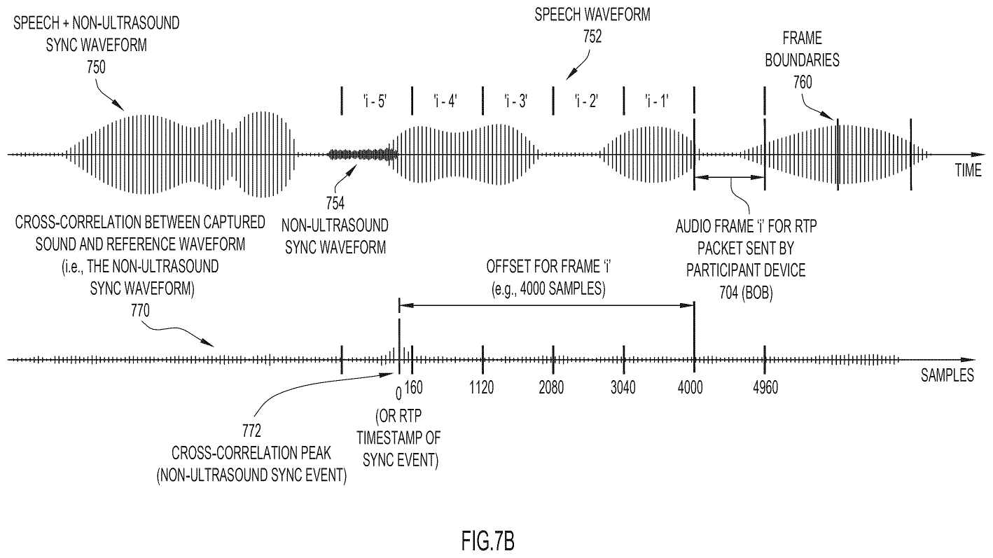

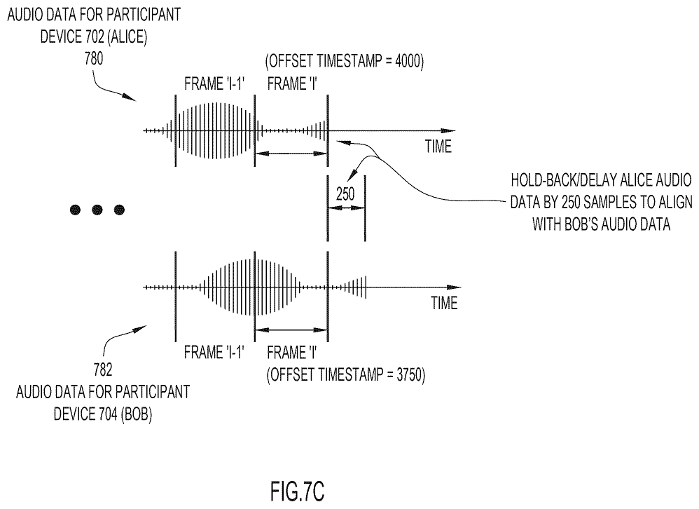

In another approach, non-ultrasound emissions of a synchronization sound waveform can be broadcast by the leader device of the audio group. In some embodiments, the synchronization sound waveform can be generated using a perceptual masking or filtering process to ensure that it is imperceptible/inaudible to participants of the conference call. Prior to, or at the beginning of the conference call, a reference synchronization waveform, such as frequency information, period/duration, and/or any other parameters that may define the synchronization sound waveform can be provided to each of the participant devices 102, 104, and 106 determined to be proximate to one another and grouped into the audio group. For example, the waveform parameters can be provided to each of the participant devices 102, 104, and 106 by the conference server. During operation of system 100, the leader device can broadcast the synchronization sound waveform (via its loudspeaker), along with any other audio signal data for the conference call. The synchronization sound waveform can be received or captured by the leader and follower devices (e.g., via their respective microphones) along with any sound signal data captured by each of the microphones of the various participant devices 102, 104, and 106 (e.g., participants speaking, etc.). The participant devices 102, 104, and 106 can perform a cross-correlation between the reference synchronization waveform and the sound signal data in order to determine synchronization information; specifically, time or sample offset information (e.g., a timestamp, etc.) related to the synchronization sound waveform broadcast, can be embedded in packets of audio data streamed to the conference server 116 in which the synchronization information enables the conference server to synchronize the audio data streams of the multiple devices to a common wall clock. This approach is referred to herein as the ‘non-ultrasound approach’ for synchronizing audio streams of participant devices in proximity to one another during a conference call to a common wall clock. FIGS. 7A, 7B, 8A, 8B, and 9 discussed below provide various example details associated with the non-ultrasound approach for synchronizing audio streams of participant devices in proximity to one another to a common wall clock.

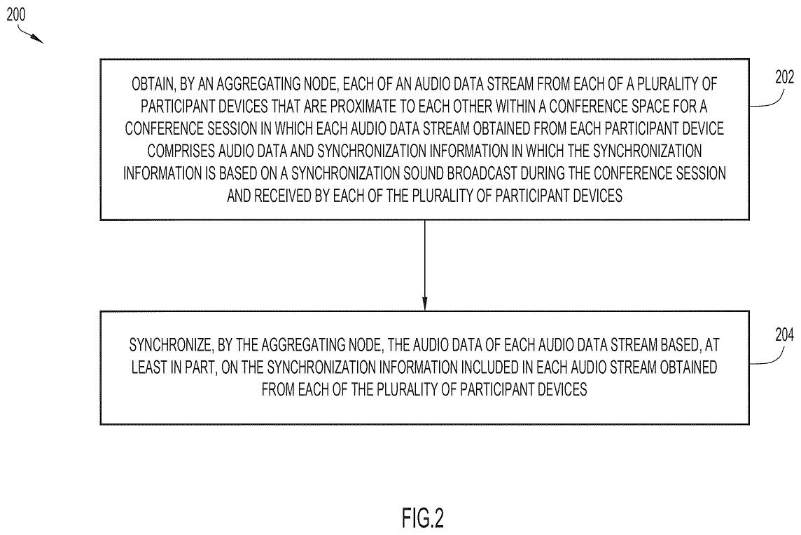

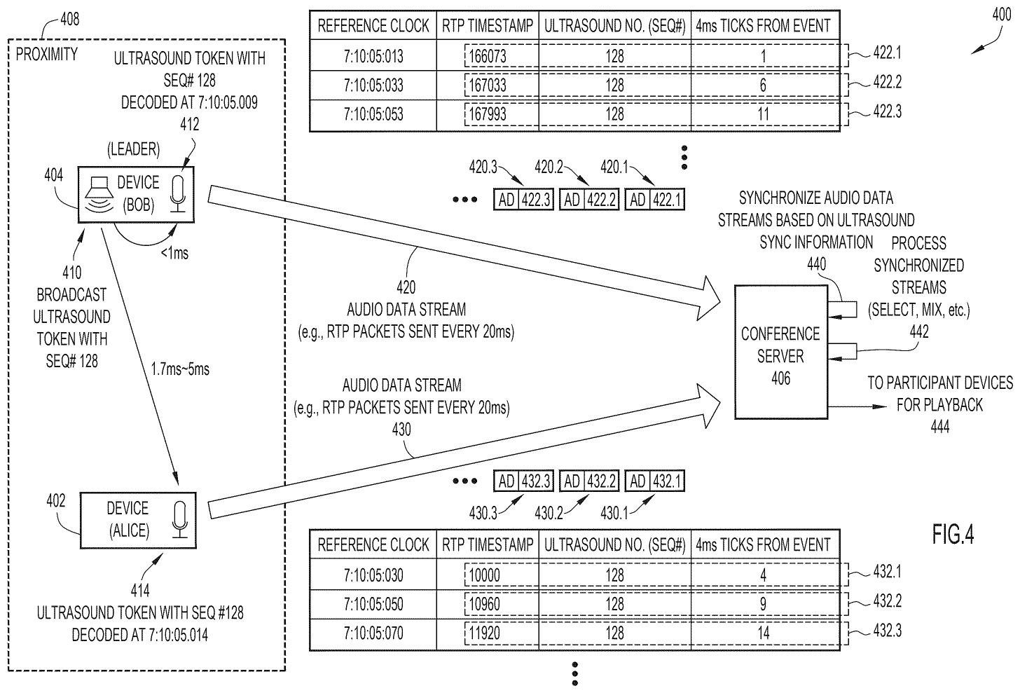

For either approach, operations of system 100 may broadly involve features as illustrated with reference to FIG. 2, which is a flow chart of a method 200 for synchronizing multiple audio streams during a conference call for multiple participant devices that are proximate to one another. In one example, method 200 may be performed by an aggregating node, such as conference server 116 of FIG. 1A, conference server 406 of FIG. 4, or conference server 706 of FIG. 7A.

As shown at 202, the method may broadly include obtaining, by a aggregating node, each of an audio data stream from each of a plurality of participant devices that are proximate to each other within a (shared) conference space for a conference session in which each audio data stream obtained from each participant device comprises audio data and synchronization information in which the synchronization information is based on a synchronization sound broadcast during the conference session and received by each of the plurality of participant devices.

As shown at 204, the method may include synchronizing, by the aggregating node, the audio data of each audio data stream based, at least in part, on the synchronization information included in each audio stream obtained from each of the plurality of participant devices. In at least one embodiment, the synchronizing may include synchronizing the audio data of each audio data stream to a common wall clock. In at least one embodiment, the synchronizing may include adjusting audio data of each data stream to be time-aligned with respect to each other for packets or blocks of audio data received by the aggregating node.

Although various embodiments are discussed with reference to a conference server that can manage a given conference call, it is to be understood that synchronization of multiple audio streams of devices in proximity to one another for embodiments herein can be performed by any device, node, server, service, apparatus, or the like that aggregates and/or processes multiple audio streams from a given location (e.g., an aggregating node).

As discussed in further detail herein with reference to each of the different synchronization approaches, such as the ultrasound approach and the non-ultrasound approach noted above, consider further that one participant device of the plurality of participant devices is selected to be a leader device for the conference session and the other participant devices of the plurality of participant devices are follower devices for the conference session in which the leader device broadcasts the synchronization sound and also receives the synchronization sound and each of the follower devices also receives the synchronization sound broadcast by the leader device.

### Ultrasound Approach for Synchronizing Audio Streams

Turning first to the ultrasound approach for synchronizing audio streams of at least two participant devices in proximity to one another to a common wall clock in which the synchronization sound is an ultrasound token broadcast by the leader device, consider FIG. 3A, which is a schematic diagram illustrating an example ultrasound token format 300 that may be utilized for each of multiple ultrasound tokens that can be broadcast by the leader device during the conference session. Each ultrasound token broadcast by the leader device may include a header field (HDR) 302, sequence number field 304, and an IP address field 306. The sequence number field 304 may have an 8-bit width with the remaining fields making up the remainder of a 64-bit RZSS token.

During operation, the sequence number field 302 for each ultrasound token broadcast by the leader device can start from a value of 0 (SEQ #0) and be incremented by a value of 1 for each token broadcast thru a value of 255 (SEQ #255) for a total of 256 sequence numbers. The IP address field 304 can be set to a value of ‘0’ (zero), e.g., ‘0.0.0.0’, which may not indicate an IP address, but rather may be a flag indicating to each receiving participant device 102, 104, and 106 that the token is a multi-mic synchronization token.

Referring to FIG. 3B, FIG. 3B is a diagram depicting example details of ultrasound token broadcast schema 350 that can be utilized during a conference call to facilitate synchronization for multiple audio streams, according to an example embodiment. As shown in FIG. 3B, the leader device can broadcast (352) each of multiple ultrasound tokens in which it can take approximately 500 milliseconds (ms) to complete the token broadcast.

Each ultrasound token broadcast can be referred to herein as a synchronization (sync) event or detection event. The sync events can be randomly spaced in time. For example, sync event 1 (SEQ #1) can be broadcast 0.5 seconds after sync event 0 (SEQ #0), sync event 2 can be broadcast 1.3 seconds after sync event 1, and so on.

Each participant device 102, 104, and 106, whether it is selected to be the leader device or is a follower device, can receive/detect and decode each ultrasound token broadcast by the leader, as generally shown at 354. In decoding an ultrasound token, a given participant device can: 1) record/store the sequence number of the ultrasound token and the absolute time at which the token was detected (shown in FIG. 3B as ‘T_{DET}’), and 2) if the time passed from the last detection of an ultrasound token is smaller less than (4 ms*255) the participant device marks or otherwise embeds the sequence number and timing offset information relative to the T_{DET} (e.g., collectively, synchronization information, as discussed herein) in each of multiple RTP packets (containing audio data heard by each of the participant devices) sent to the conference server 116. It is noted there will be no inclusion of sync event data in RTP packets by the leader or follower devices if the last ultrasound token was detected 1 second ago or later (e.g., the time passed is greater than or equal to (4 ms*255). Thus, it is desirable for the leader to transmit a new token with a new sequence number in relatively quick succession (e.g., in less than 1 second).

To further illustrate example details of the ultrasound approach, consider FIG. 4, which is a block diagram of a system 400 and example processes that can be utilized to synchronize multiple audio streams of participant devices in proximity to one another to a common wall clock utilizing ultrasound tokens, according to an example embodiment. In at least one embodiment, system 100 includes a participant device 402 (that can be used by a corresponding participant ‘Alice’) and a participant device 404 (that can be used by a corresponding participant ‘Bob’) that are involved in a conference call facilitated via a conference server 406 (e.g., an aggregating node) involving another (remote) participant/participant device, such as, a participant device used by a participant ‘Dave’ (not shown in FIG. 4. Consider for the example of FIG. 4 that participant device 402 and participant device 404 are determined to be in proximity 408 to one another, for example, using the ultrasound detection techniques as discussed above for FIG. 1A, and that participant device 404 (Bob) is selected to be the leader device such that participant device 402 (Alice) is a follower device for the present example.

In the example of FIG. 4, consider that participant device 402 interfaces with the conference server 406 via a first network (not shown) and that participant device 404 interfaces with the conference server 406 via a second network (not shown) that is different than the first network associated with the participant device 402.

During operation of system 400, consider further that participant device 404 broadcasts ultrasound tokens (sync or detection events), as generally shown at 410, that are heard/detected both by participant device 404 (Bob, leader) and participant device 402 (Alice, follower), in addition to other audio data (AD) that can be heard/detected by both the participant devices 402 and 404.

Audio data heard/processed by each participant device 402 and 404 can be sent towards the conference server 406 via a corresponding audio data stream including RTP packets (also referred to herein as audio data packets) in which each packet includes audio data (AD) and metadata. The metadata can include an RTP timestamp and synchronization information, such as the sequence number (SEQ #) of a detected ultrasound token broadcast and time offset information that indicates a number of 4 ms ‘ticks’ from the time at which the ultrasound token (for a given SEQ #) was detected. Generally, a ‘tick’ may be characterized as the minimum amount of time that the clock increases its discrete value, which for RTP is 4 ms.

The metadata can be carried in a header of the RTP packets while audio data is carried in a payload of the RTP packets. The RTP packets can carry audio frames consisting of 10 ms, 20 ms, or 40 ms ‘chunks’ or samples of audio data/media (e.g., 960 samples or the like). It is to be understood that the length of an audio frame carried in packet is encoder/decoder (codec) dependent and may also be driven by delay requirements. Generally, the shorter audio frame/packet the better E2E latency, however, shorter audio frames/packets can result in sending more packets for a given amount of time. Sending more packets can result more headers and metadata and, in general, more overhead and bandwidth used. A frequently used size is 20 ms, which may provide a good compromise between latency and metadata overhead.

The number of samples in a packet is audio frame length dependent, as well as dependent on the number of channels and sample rate. In examples discussed herein, a 20 ms audio frame length is discussed in reference to a 48000 hertz (Hz) sample rate and mono signal that translates to 960 samples in audio frame/packet.

Further, per Internet Engineering Task Force (IETF) Request for Comments (RCF) 3550, the RTP timestamp is driven by the sampling rate with the initial value selected at random. For example, for fixed-rate audio, the RTP timestamp clock may be incremented by one for each sampling period.

Various examples discussed herein may reference a 20 ms audio frame length and a 48 kilohertz (kHz) sampling rate, but such examples are not meant to limit the broad scope of embodiments herein. It is to be understood that any audio frame size and sampling rate may be utilized under embodiments of the present disclosure. For instances in which the sampling rate among participant devices may differ between streams, the sampling rate can be normalized to the leader's sampling rate before performing any comparisons by the conference server.

As illustrated in FIG. 4, the RTP packets in this example can be sent by each participant device 402 and 404 to the conference server 406 every 20 ms.

For example, as shown in FIG. 4, participant device 402 (Alice) sends an audio data stream 430 to the conference server 406 that includes RTP packets 430.1, 430.2, and 430.3, each including audio data and corresponding metadata 432.1, 432.2, and 432.3. Further, participant device 404 (Bob) sends an audio data stream 420 to the conference server 406 that includes RTP packets 420.1, 420.2, and 420.3, including audio data and corresponding metadata 422.1, 422.2, and 422.3.

Embodiments herein assume an ultrasound propagation speed (in air) is 300 meters per second (m/s). Based on this assumption, for example, an over-the-air broadcast propagation delay (error) of 10 ms may equate to participant devices (in proximity to one another) being approximately 3 meters (m) apart. An assumption that participant devices may be less than 5 m apart can equate to approximately 17 ms of error (propagation delay) between the audio data of each of the audio streams captured/set participant devices proximate to one another.

For example, as shown in FIG. 4, consider that participant device 404 broadcasts an ultrasound token with sequence number 128 (SEQ #128), as shown at 410, which the participant device 404 also detects the ultrasound token (via its microphone, as shown at 412) at a detection/decode time of 7:10:05.009 (based on the system or reference clock of participant device 404) [in which the detection/decode time is expressed in a time format of Hours:Minutes:Seconds. Milliseconds]. The microphone of participant device 404, likely being embedded within a shell/case of a laptop and thus, close to the loudspeaker of the device, means that (using the assumed ultrasound propagation delay of 300 m/s) the participant device 404 can detect the ultrasound token broadcast less than Ims from the time at which it was broadcast. It is noted that the time that it takes to decode the sequence number of the ultrasound token does not impact the techniques presented herein, rather, the relevant information encoded into audio packets sent to the conference server involves the relationship of when the ultrasound token reaches a device's microphone compared to when human speech reaches the microphone.

For the example of FIG. 4, participant device 402 may be 1.7 m away from participant device 404, which means that it can take approximately 5 ms for participant device 402 to detect/decode the ultrasound token broadcast. For instance, consider that participant device 402 detects (via its microphone, as shown at 414) the ultrasound token with sequence number 128 (SEQ #128) at a detection/decode time of 7:10:05.014 (based on the system or reference clock of participant device 402).

Based on the distance between the participant devices 402 and 404 there can be drift or error between the audio streams of the devices sent to the conference server 406. Further, RTP packets sent by the participant devices 402 and 404 to the conference server can be delayed due to network propagation delays. It is assumed that the error introduced by the propagation time over the air of a given ultrasound token is negligible, relative to the error that can be introduced due to network propagation delay(s) between each of at least two proximate participant devices and an aggregating node (e.g., drift that is to be calculated and removed), so the detection time of an ultrasound token sync event can be used for clock synchronization purposes in accordance with embodiments herein. Thus, in order to cope with potential network propagation delays, the synchronization information included in each RTP packet can be used to synchronize audio data of each of the streams 420 and 430 to a common wall clock, such as marking the RTP timestamp of follower packets in terms of or relative to the RTP timestamp of the leader packets. Stated differently, a plus or minus RTP offset value can be determined for each follower stream relative to the RTP timestamp of the leader stream for a given broadcast ultrasound token sequence number.

In the present example, consider that RTP packet 420.1 sent (at a time of 7:10:05.013) to the conference server 406 includes an RTP timestamp of 166073 included in metadata 422.1 (within a header of the packet) and also includes synchronization information, such as the ultrasound token sequence number 128 for the token detected at 7:10:05.09 along with a value of 1 for the number of 4 ms ticks from the sync event for the time at which the packet is sent by participant device 404 (e.g., 7:10:05.013−1*4 ms=7:10:05.09). Broadly, a calculation for determining the number of 4 ms ticks from a sync event or stated differently, the amount of time that has passed since a sync event, can be calculated, as shown in Equation 1 (Eq. 1), below:

$$Number of 4 m ticks = ( current\_time \_in \_ms - abs\_us \_token \_detection \_time ) / 4 \qquad EQ . 1$$

For Eq. 1, ‘current_time_in_ms’ is the current system/reference time for a given participant device at the time at which an RTP packet is sent in milliseconds and ‘abs_us_token_detection_time’ is the absolute detection time of a given ultrasound (us or US) token.

Participant device 404 can determine/embed similar information for the next 20 ms of audio data included in RTP packet 420.2 sent to the conference server 406. For example, in RTP packet 420.2, participant device 404 includes an RTP timestamp of 167033, and synchronization information, such as the ultrasound sequence number 128 for the token detected at 7:10:05.09 along with a value of 6 for the number of 4 ms ticks from the sync event for the time at which the packet is sent by the participant device (e.g., 7:10:05.033−6*4 ms=7:10:05.09). Similar information can be included in RTP packet 420.3, and so on, for other RTP packets sent to the conference server 406 for the audio data stream 420 across other ultrasound token broadcast/detection events (e.g., for SEQ #129, SEQ #130, etc.).

Participant device 402 can embed similar metadata in RTP packets of the audio data stream 430 sent to the conference server 406, relative to the sync event detection time of 7:10:05.014 by the participant device 402 of the broadcast of ultrasound token having sequence number 128. For example, RTP packet 430.1 sent to the conference server (at a time of 7:10:05.030) can include an RTP timestamp of 10000, and synchronization information, such as the ultrasound token sequence number 128 along with a value of 4 for the number of 4 ms ticks from the sync event for the time at which the packet is sent by participant device (e.g., 7:10:05.030−4*4 ms=7:10:05.014). Similarly, in RTP packet 430.2, participant device 402 includes an RTP timestamp of 10960, and synchronization information, such as the ultrasound sequence number 128 for the token detected at 7:10:05.09 along with a value of 9 for the number of 4 ms ticks from the sync event for the time at which the packet is sent by the participant device (e.g., 7:10:05.050 9*4 ms=7:10:05.014). Similar information can be included in RTP packet 430.3, and so on, for other RTP packets sent to the conference server 406 for the audio data stream 430 across other ultrasound token broadcast/detection events (e.g., for SEQ #129, SEQ #130, etc.).

Upon receiving RTP packets of the audio data streams 420 and 430, the conference server 406 can synchronize audio data of the streams to a common wall clock using the RTP timestamp and synchronization information included in each RTP packet, as generally shown at 440. That is, conference server 406 can synchronize the audio data of the follower stream(s) in terms of an RTP timestamp offset relative to the leader stream based on the ultrasound detection time information included in each RTP packet.

For each received RTP packet, the conference server 406 can extract the ultrasound token sequence number, the number of 4 m ticks from a sync event, and the RTP timestamp, each of which can be labeled as follows for the synchronization process performed by the conference server 406:
Ultrasound token sequence number: RTP_packet.us_seq_number
Number of 4 ms ticks from a sync event: RTP_packet.us_4 ms_tick
RTP timestamp: RTP_packet.timestamp

For a given received RTP packet the conference server can calculate when the ultrasound token was detected by a given participant device, expressed using the RTP timestamp contained in the received RTP packet or stated differently, the RTP timestamp of the participant device at the time the ultrasound sync event was detected, as shown in Equation 2 (EQ. 2), below:

$$US\_timestamp = RTP\_packet . timestamp - ( samples\_per \_ 4 ms\_tick * RTP\_packet . us\_ 4 ms\_tick ) \qquad EQ . 2$$

For Eq. 2, ‘samples_per_4 ms_tick’ represents the number of timestamp ticks per 4 ms. For example, based on a sampling rate of 48 kilohertz (kHz) for audio data samples generated by a given participant device, it is assumed that there are 48 ticks per 1 ms of RTP timestamp clock for audio clock ↔sample rate such that ‘samples_per_4 ms_tick’=(4*48)=192. However, it is to be understood that other sampling rates can be used such that the ‘samples_per_4 ms_tick’ can be calculated based on a given sampling rate, as follows: sampling rate*.001 sec=number of ticks per 1 ms.

For example, based on Eq. 2, the conference server can determine that the RTP timestamp for the time at which (follower) participant device 402 detected the ultrasound token sync event for SEQ #128 for RTP packet 430.1, as follows:

US_timestamp(follower)=10000−(192*4)=9232

Accordingly, for RTP packet 430.1, the RTP timestamp for the time at which (follower) participant device 402 detected the ultrasound token sync event for SEQ #128 is calculated to be 9232.

Further, based on Eq. 2, the conference server 406 can determine that the RTP timestamp for the time at which (leader) participant device 404 detected the ultrasound token sync event for SEQ #128 for RTP packet 420.1, as follows:

US_timestamp(leader)=166073−(192*1)=165881

Accordingly, for RTP packet 420.1, the RTP timestamp for the time at which (leader) participant device 404 detected the ultrasound token sync event for SEQ #128 is calculated to be 165881.

In order to synchronize the follower RTP packet and the leader RTP packet to a common wall clock, the conference server 406 determines the difference between the RTP timestamp of the leader and the follower (for the sync event), as follows, 165881−9232=156649, which can be labeled as ‘RTP_diff_L_F’, also referred to herein as the ‘RTP offset’ between the follower and leader streams, as follows:

RTP_diff_L_F=165881−9232=156649

The difference between the leader and follower stream can be used to determine the drift between the leader participant device 404 audio data stream 420 and the follower participant device 402 audio data stream 430 due to network propagation delays experienced by the streams transmitted towards conference server and, further to align the audio data of the follower stream relative to the leader stream such that the conference server 406 can further process the synchronized/aligned audio streams, as generally shown at 442 of FIG. 4, such as mixing the audio streams or selecting one of the audio streams for playback by participant devices, as generally shown at 444. It is understood that the audio streams obtained from participant devices proximate to each other at a given location (within a conference room) are not send back to such devices; rather the audio from the proximate devices would be sent to remote participant device(s) (e.g., Dave in this example) in order to “cut” a feedback loop being created within the conference room. Through synchronization, as discussed for embodiments herein, streams obtained from the proximate devices can be aligned and mixing of the streams or selection of a given stream for playback can be used to remove echo from the audio.

For the synchronization, the follower's RTP timestamp of packet 430.1 can be marked, expressed, or updated using the “clock” of the leader, such the RTP offset (RTP_diff_L_F), as shown in Equation 3 (EQ. 3), as follows:

$$RTP\_packet ( follower ) . leader\_timestamp = RTP\_packet . timestamp + RTP\_diff \_L \_F \qquad EQ . 3$$

In this example, the RTP timestamp of packet 430.1, updated in terms of the leader's clock; thus, synchronizing the streams to a common wall clock, can be marked as RTP_packet(420.1).leader_timestamp=10000+156649=166649.

Thus, for the received streams/packets in the present example, the leader stream (Bob, participant device 404) is slower than the follower stream (Alice, participant device 402) by:

166649−166073=576RTP ticks/48ticks/ms=12ms

Stated differently, after normalizing to the common leader timestamp, the follower device has a higher RTP timestamp than the leader, which means that the follower has ‘newer’ data, that is, the follower is faster, and the leader is slower in this example. The above equations, EQ. 1 and EQ. 2, and various may provide a foundation through which the conference server 440 can perform synchronization across multiple packets received for the audio data stream 420 of the leader participant device 404 and the audio stream 430 of the follower device 402 such that audio data packets received from the follower can be marked with normalized timestamps of the leader.

For example, consider that sync events 128, 129, and 130 are randomly spaced in time (e.g., ultrasound tokens for SEQ #128, 129, and 130 broadcast at random times by (leader) participant device 404), such that sync event 128 is broadcast 0.5 seconds after sync event 128, sync event 129 is broadcast 1.3 seconds after sync event 128, and sync event 130 is broadcast 0.5 seconds after sync event 129.

In order to determine the ultrasound detection RTP timestamp difference between the leader stream (420) and the follower stream (430), normalized RTP timestamps are to be calculated over the same sync events. For each stream, the timestamp of the ultrasound event (in RTP timestamps) may be characterized generally as,
127: timestamp X
128: timestamp X+500 [ms]*48 [timestamp ticks/ms]
129: timestamp X+500 [ms]*48 [timestamp ticks/ms]+1300*48
130: timestamp X+500 [ms]*48 [timestamp ticks/ms]+1300*48+500*48

However, the streams received from the leader participant device 404 and from the follower participant device 402 can start at different times and thus may have a different number of packets for a given sync event. In order to normalize for such discrepancies, the conference server 406 can check each incoming RTP packet received for each audio data stream to determine whether a synchronization information is included in a header of a given RTP packet.

In some embodiments, synchronization information can be carried in vendor specific extension header, which can be identified by an extension header value, flag, or the like in RTP packets including such an extension header.

Upon determining that a particular received RTP packet carries synchronization information, the conference server 406 can extract from the header:
The ultrasound token sequence number: RTP_packet.us_seq_number
Number of 4 ms ticks from a sync event: RTP_packet.us_4 ms_tick
RTP timestamp: RTP_packet.timestamp

Next, the conference server 406 can calculate when the ultrasound token was detected by a given participant device using the RTP timestamp contained in the packet, using EQ. 2 [US_timestamp=RTP_packet.timestamp−(samples_per_4 ms_tick*RTP_packet.us_4 ms_tick] and the US_timestamp for the packet can be added to an array associated with the audio data stream for the given participant device that is used to store estimated US_timestamps of each of a given sync event, calculated for each packet containing synchronization information, as shown below:
stream_metadata [stream_id].ultrasound_events_array[RTP_packet.us_seq_number]. add(RTP_packet.timestamp-samples_per_4 ms_tick*RTP_packet.us_4 ms_tick, current_system_time_ms)

For the array, shown above, the ‘stream_id’ can be used to uniquely identify a given stream for a particular participant device and ‘current_system_time_ms’ is the system time of the conference server 406. As there may be a wrapping of the ultrasound token sequence number approximately every 5 minutes, the receive time of audio data can be indexed relative to the system time of the conference server in order to avoid comparing stale tokens with current tokens. Thus, for a given current system time of XX:XX:XX.XXX a corresponding entry in the array for a given device can correspond to ‘add(US_timestamp, XX:XX:XX.XXX)’.

In at least one embodiment, an average of a given stream array can be used to calculate a smoothed or normalized estimation of the RTP timestamp for an ultrasound sync event detected by the particular participant device. For example, an average of an array for sync event 128 can be calculated as:

Avg(stream_metadata[steam_id].ultrasound_events_array[128])

It is assumed that 2 RTP packets received for a particular ultrasound sync event are sufficient for performing a valid estimation of the RTP timestamp for detection of the sync event by a particular participant device.

For the present example, in one embodiment, to calculate an estimation of the RTP difference between the audio data stream 420 for (leader) participant device 404 and the audio data stream 430 for (follower) participant device 402, smoothing/normalization can be performed by the conference server 406. In this example, assume that the ‘stream_id’ for (leader) participant device 404 is set to ‘L’ and that the ‘stream_id’ for (follower) participant device 402 is set to ‘F’ and that audio data stream 430 (for the follower) has stored arrays of sync event timestamps for sync events 127, 128, 129, and 130, while audio data stream 420 (for the leader) has stored arrays of sync event timestamps 128, 129, and 130, such that the RTP difference between the streams for common sync events 128, 129, and 130 in this example, can be calculated using an averaging process, as follows:

### RTP_diff_L_F=

(Avg(stream_meta_data [F]. ultrasound_events_array[128])−Avg(stream_meta_data [L]. ultrasound_events_array [128])+
Avg(stream_meta_data [F]. ultrasound_events_array[129])−Avg(stream_meta_data [L]. ultrasound_events_array[129])+
Avg(stream_meta_data [F]. ultrasound_events_array[130])−Avg(stream_meta_data [L]. ultrasound_events_array[130]))/3

Based on the smoothed RTP_diff_L_F (RTP offset) calculation, RTP packets received for the (follower) participant device 402 can be marked in terms of the RTP offset relative to the leader participant device 404, as above for EQ. 3, as:

RTP_packet(follower).leader_timestamp=RTP_packet.timestamp+RTP_diff_L_F

Accordingly, leader and follower packets can be synchronized to a common wall clock, that is, a normalized RTP offset (RTP_diff_L_F) that can be calculated for each of a follower device relative to a leader device among co-located devices in proximity to one another within a shared conference space. The RTP can be recalculated on every received packet in order to improve accuracy of the calculated difference. In at least one embodiment an array for a given sync event for a particular device can be cleared when the last entry in the array is older than 256*500 ms (e.g., approximately half the time needed for an ultrasound sequence number to be repeated).

Further, an SSRC change determined by the conference server 406 for a given sender/source device indicates that previous RTP synchronization data for the given source cannot be relied on, as an SSRC change may mean a reset of the RTP timestamp by the sender, or a sample rate change due to a codec change. For instances in which the conference server 406 determines an SSRC change for a given stream, a reset of the RTP difference and resynchronization for the stream can be triggered.

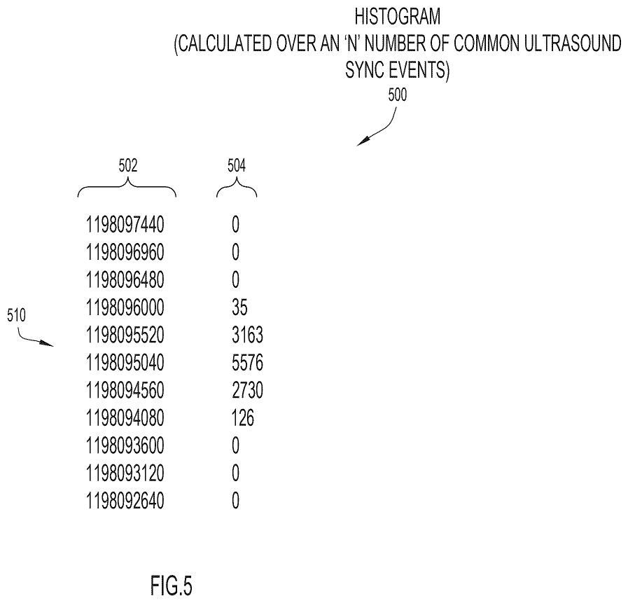

Although smoothing or normalization of the RTP_diff (RTP offset) value calculated between leader and follower streams may be performed using an averaging process as discussed above, normalization may also be performed using a histogram process, as discussed with reference to FIG. 5, which is a schematic diagram illustrating an example histogram 500 that can be generated using histogram process that may be based on a number of sync events detected by a given leader device and a particular follower device (neither shown in FIG. 5) for which synchronization information can be included in RTP packets sent to a conference server (e.g., conference server 116 or conference server 406). The histogram 500 can be generated using the histogram process for calculating a normalized timestamp difference between an audio stream of the leader device and follower device for synchronizing the streams to a common wall clock, according to an example embodiment.

For the example histogram 500 illustrated for FIG. 5, a number of bins are shown at 502, in which each bin corresponds to a common sync event between the leader and follower for which a number of entries in the bin for which an RTP_diff calculation, as shown at 504, is populated. For the histogram process, the bin having the largest number of entries, and it corresponding RTP_diff calculation can be used update the RTP timestamp of follower RTP packets to align with the leader packets. As illustrated in FIG. 5, bin 510 may be selected as the bin having the largest number of entries such that the value of 5576 can be used for updating the RTP timestamp of follower packets to be aligned with the RTP timestamp of corresponding leader RTP packets.

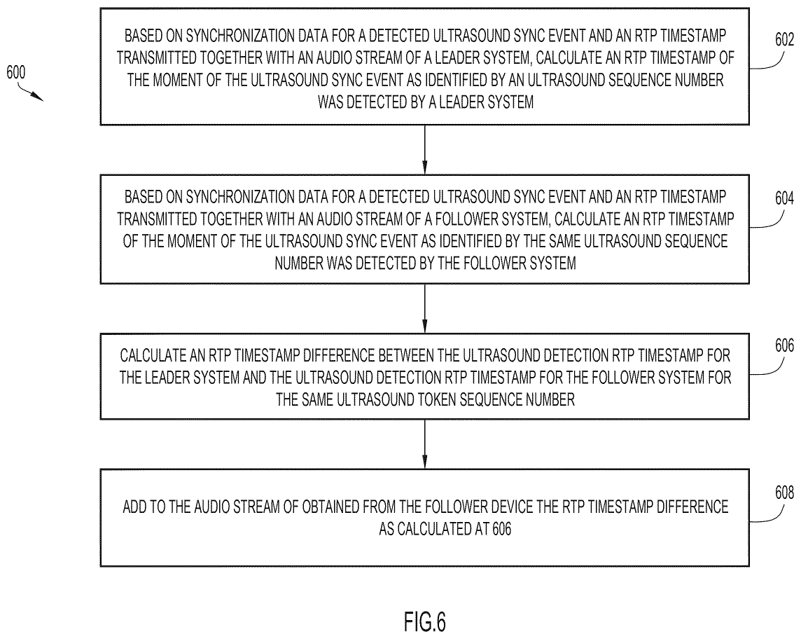

Referring to FIG. 6, FIG. 6 is a flow chart depicting a method 600 for synchronizing audio streams based on ultrasound sync events, according to an example embodiment. In at least one embodiment, method 600 may be performed by an aggregating node, such as conference server 116 or conference server 406, in order to synchronize audio streams received from multiple participant devices containing various synchronization information that can be provided by the participant devices under the ultrasound sync approach.

At 602, the method may include based on synchronization data (e.g., an ultrasound SEQ #and 4 ms ticks) for a detected ultrasound sync event and an RTP timestamp transmitted together with an audio stream (e.g., at least one RTP packet) of a leader system, calculate an RTP timestamp of the moment of the ultrasound sync event as identified by an ultrasound sequence number was detected by the leader system (e.g., US_timestamp (leader) in terms of an RTP timestamp value, as discussed above with reference to EQ. 2).

At 604, the method may include, based on synchronization data and an RTP timestamp transmitted together with an audio stream (e.g., at least one RTP packet) of a follower system, calculating an RTP timestamp of the moment the ultrasound sync event, as identified by the same ultrasound sequence number, was detected by the follower system (e.g., US_timestamp (follower), as discussed above with reference to EQ. 2).

At 606, the method may include calculating an RTP timestamp difference between the ultrasound detection RTP timestamp for the leader system and the ultrasound detection RTP timestamp for the follower system for the same ultrasound token sequence number (calculating RTP_diff_L_F, as discussed above with reference to EQ. 3). The difference can be smoothed over multiple ultrasound token instances.

At 608, the method may include adding, to the audio stream of obtained from the follower device, the RTP timestamp difference as calculated at 606. The aggregating node thus treats the leader's RTP timestamp as a common wall clock.

It is to be understood that method 600 can be performed for each of multiple follower systems that may be present within a shared conference space. Further, it is to be understood that method 600 can be extended to the generation of arrays of US_timestamps for a given sync event for which a given participant device (leader or follower) has included such synchronization information in multiple RTP packets (of an audio stream) sent to the conference server. Based on arrays of sync event timestamps, the conference server can normalize or smooth the RTP timestamp differences using an averaging process or a histogram process, as discussed above, to perform the synchronization.

The same approach may be used for other RTP fields or extensions that convey a monotonic platform time, such as WebRTC (web Real-Time Communications) Absolute Capture Time.

Such synchronization of streams to a common wall clock based on ultrasound sync events, as discussed above with reference to FIGS. 3A, 3B, 4, 5, and 6 can provide several advantages over current solutions. For example, the same signal and sensors can be used for capturing audio and for delay estimation. Further, timing events/synchronization information can be embedded into media stream as metadata such that the information is accessible when media is processed.

Additionally, the synchronization as prescribed herein does not rely on RTT/2 estimates and is not vulnerable to non-uniform uplink and downlink delays. A valid estimate/update can be delivered faster than an RTT, especially in adverse network conditions, which can be crucial for cases when someone joins a conference in the middle of the meeting (e.g., physically enters a huddle room).

Further, embodiments herein may be implemented with limited change to the conferencing infrastructure and can enable a smooth transition between streams during a switch (e.g., selecting one stream for playback), and can reduce the cost of transcoding on the conference server. For example, in combination with quality metrics, embodiments herein may provide capabilities for performing aligned quality comparison and filtering out streams that have lower quality prior to decryption or decoding. Further multi-mic solutions that may utilize embodiments herein to improve their speech pick up performance in large conference rooms.

Additionally, embodiments herein involving both the ultrasound synchronization techniques described above and the non-ultrasound synchronization techniques described advantageously below provide for aligning audio received from different devices/sources proximate to one another, for example, in a conference room. That is, techniques as described herein may enable ‘freezing’ the audio at the point of microphone capture. It doesn't matter if one system may take longer to process audio and send it to the network or if an audio stream takes longer to reach an aggregating node/conference server. Rather, the aggregating node only needs to know when the audio hit the microphone of a particular device. Determining the time at which audio was heard be device can be achieved in accordance with the ultrasound and non-ultrasound synchronization token techniques as discussed herein.

Consider, another illustrative example, as follows. For example, consider that two participants, Alice and Bob, are in a room for a multi-party conference call and Alice says, “Hi Bob” and Bob says, “Hi Alice” such that each microphone of each user's devices picks up “Hi Bob Hi Alice.” In this example, the conference server can select Alice's microphone for the “Hi Bob” audio and can select Bob's microphone for the “Hi Alice” audio to be sent to a remote participant, say, Carol. When the conference server stitches together the two unaligned microphones, it is important that the resultant audio is not erroneous, for example, not resulting in something erroneous, such as “Hi Bob Alice,” “Hi Bob Hi Hi Alice,” etc.

For this example, consider that a synchronization signal (ultrasound or non-ultrasound) is broadcast such that the sync event for both microphones is just before the first “Hi” (from Alice). Further, consider that a first participant device devices the audio into two frames, a first frame including “ . . . Hi” and a second frame including “Bob Hi Alice” and the second participant device puts the entire utterance into one frame. In this example, the second device can include metadata sync information in the data indicating that the frame occurred just after the sync event and the first device can include metadata sync information indicating that the second frame started two letters after the sync event. With this sync information, the conference server can stitch together the audio frames received from the two participant devices, in accordance with techniques as discussed for embodiments herein.

### Non-Ultrasound Approach for Synchronizing Audio Streams

Turning next to the non-ultrasound approach for synchronizing audio streams of at least two participant devices in proximity to one another to a common wall clock in which the synchronization sound signal is a sound broadcast by a device within proximity to the two participant devices, consider FIG. 7A, which is a diagram 700 illustrating example details associated with a non-ultrasound approach for synchronizing audio streams of multiple participant devices in proximity to one another during a conference call, according to an example embodiment.

For the embodiment of FIG. 7A, consider that two participant devices, a participant device 702 (of a participant ‘Alice’), and a participant device 704 (of a participant ‘Bob’) are determined to be in proximity 708 to each other in a shared space (e.g., conference room) for a conference call hosted via a conference server 706. For the conference call, consider participant device 702 is selected to be the leader device (e.g., Alice=leader/leader device), while participant device 704 is the follower device (e.g., Bob=follower/follower device) for various example details discussed with reference to FIG. 7A. FIG. 7B is a schematic diagram illustrating example sound waveform details associated with the conference call.

Broadly, as noted above, the non-ultrasound approach involves non-ultrasound emissions of a synchronization (sync) sound waveform, also referred to herein as a ‘non-ultrasound sync waveform’ or ‘non-ultrasound sync signal’ that can be broadcast by the leader device of an audio group (e.g., broadcast by (leader) participant device 702 for an audio group including 702 and 704) or may be broadcast by a non-participant device that is within a given conference room, such as a multimedia teleconference/room device including at least a loudspeaker. The device broadcasting the non-ultrasound sync waveform may also be referred to as a synchronization source.

Prior to or at the beginning of the conference call, a reference synchronization waveform, such as frequency information, period/duration, and/or any other parameters that may define the non-ultrasound sync waveform can be provided to each of the participant devices 702 and 704 determined to be in proximity 708 to one another and grouped into the audio group. For example, the reference synchronization waveform parameters can be provided to each of the participant devices 702 and 704 by the conference server 706 in at least one embodiment. In another embodiment, the reference synchronization waveform (parameters) can be sent to follower participant devices from the synchronization source (e.g., the leader device).

During operation of the system of FIG. 7A, consider in at least one embodiment, that the (leader/Alice) participant device 702 periodically broadcasts the non-ultrasound sync waveform (via its loudspeaker) along with any playback audio that may be received from the conference server 706, as shown at 710 of FIG. 7A, in which the non-ultrasound sync waveform can be captured by each of the microphones of each of the (leader/Alice) participant device 702, as shown at 712, and the (follower/Bob) participant device 704, as shown at 714. Speech of the participants during the teleconference within the conference room can also be captured by the microphones of the participant devices. Although in the example of FIG. 7A is discussed with reference to participant device 702 performing the non-ultrasound sync waveform, it is to be understood that the synchronization source could also be a room device proximate to participant devices 702 and 704.

In at least one embodiment, if the non-ultrasound sync waveform has a period of one (1) second, the waveform could be broadcast every 20 seconds. However, it is to be understood that the duration between broadcasts of the non-ultrasound sync signal could be varied depending on implementation, characteristics of the sync waveform, etc.

FIG. 7B illustrates an example waveform 750 that may include a speech waveform 752 with the non-ultrasound sync waveform 754 embedded therein, as captured by a microphone of a given participant device, for example, as captured by the microphone of participant device 702 (Alice). The waveform 750 is shown relative to a horizontal time axis, while the vertical axis may represent an amplitude of the waveform.

Sound (e.g., speech+non-ultrasound sync waveform) captured via the corresponding microphones of participant devices 702 and 704 may be processed continuously by perform a cross-correlation between any captured sound and the reference synchronization waveform (i.e., the non-ultrasound sync waveform) in order to determine an audio sample alignment of the non-ultrasound sync waveform broadcast by the (leader) participant device 702; thus providing an estimate of the audio propagation path between the synchronization source (participant device 702, in this example) and any receiving microphones.

For example, as shown in FIG. 7B, a cross-correlation peak 772 can be generated by participant device 702, as shown via waveform 770 that represents the cross-correlation between the captured sound and the reference waveform (i.e., the non-ultrasound sync waveform). The earliest peak of the cross-correlation (not necessarily the loudest) is used as a synchronization time point, marked in FIG. 7B as ‘0’, representing the time or sample at which the non-ultrasound sync waveform is detected by the (microphone) of participant device 702 (Alice). Stated differently, the synchronization time point may be an indication of the non-ultrasound sync event being detected by a given participant device. Although the cross-correlation peak 772 is illustrated with reference to a time domain, such as samples, the cross-correlation process can be performed in the frequency domain.

Each of participant device 702 and 704 can send a corresponding audio data stream 720 and 730 to the conference server 706, as shown in FIG. 7A, in which captured sound (audio data) and, potentially synchronization information can be sent to the conference server 706 for synchronizing the audio data streams, as generally shown at 740, via RTP packets that can also include an RTP timestamp, as discussed above for the ultrasound synchronization approach.

Generally, each participant device 702 and 704 can packetize audio/sound data within 20 ms frames, however, the frame boundaries (as generally shown at 760 of FIG. 7B) between the devices will vary and overlapping frames can reach the conference server 706 at different times. Recall, from the discussion above that that RTP packets can carry audio data in 10 ms, 20 ms, or 40 ms audio frames, which can be codec dependent and may also be driven by delay requirements. Although examples for the non-ultrasound approach are discussed with reference to 20 ms audio frames, it is to be understood that any length of audio frames can be used in conjunction with the non-ultrasound approach.

It is to be understood that time values and sample values are interrelated depending on the sample rate for audio processing performed by a given participant device. For example, a 20 ms audio frame processed at a sampling rate of 48 kHz equates to 960 samples of audio data packetized per RTP packet for a given audio data stream. An audio frame ‘i’ is labeled in FIG. 7B for purposes of discussing various features of embodiments herein.

In order to facilitate synchronization or alignment of the RTP packets received from each of the participant devices 702 and 704 under the non-ultrasound sync approach, each participant device can encode synchronization information into one or more of the RTP packets, such as within an extension header of one or more of the RTP packets. The synchronization information encoded in an extension header of a given RTP packet may be a time or sample offset timestamp indicating, for a given RTP packet send by a given participant device, an offset between the start of the frame encoded in the packet and the sample/time at which the participant device detected the non-ultrasound sync event.

As an illustrative example, consider, as shown in FIG. 7B that for a frame ‘i’ participant device 702 (Alice) can determine a timestamp offset indicating 4000 samples (e.g., approximately 83 ms for a sampling rate of 48 kHz) between the cross-correlation peak 772 for the non-ultrasound sync event detected by participant device 702 based on the cross-correlation. Thus, in this example, for an RTP packet sent to the conference server 706, for frame ‘i’ by participant device 702, a timestamp offset of 4000 can be included as synchronization information within an RTP header of the packet. It is to be understood that other audio frames sent by the wireless device can include different offset timestamps relative to the time at which the non-ultrasound sync event is detected. For example, an RTP packet for an audio frame ‘i-1’ can include a timestamp offset of 3040, an RTP packet for an audio frame ‘i-2’ can include a timestamp offset of 2080, an RTP packet for an audio frame ‘i-3’ can include a timestamp offset of 1120, and an RTP packet for an audio frame ‘i-4’ can include a timestamp offset of 160 relative to the most recent non-ultrasound sync event detected by participant device 702. However, an RTP packet for an audio frame ‘i-5’ would include an offset timestamp relative to previous non-ultrasound sync event detected by participant device, which is not shown in FIG. 7B, in which the offset timestamps would be provided in the same manner for RTP packets/audio frames sent by the participant device 702, relative to the previous non-ultrasound sync event.

Consider further for this example, that participant device 704 (Bob) sends an RTP packet to the conference server 706 for audio frame ‘i’ having an offset timestamp of 3750. In this example, upon receiving the RTP packets, the conference server 706 can synchronize the audio data of the RTP packets (e.g., as generally shown at 740, and also via FIG. 7C) by calculating a difference in the offset timestamps for the audio data received from participant device 702 (Alice, labeled 780 in FIG. 7C) for frame ‘i’ and for the audio data received from participant device 704 (Bob, labeled 782 in FIG. 7C) (e.g., 4000−3750=250). The audio data received from the participant devices 702/704 can then be aligned or synchronized such that the audio data associated with the timestamp of 4000 (received from participant device 702 (Alice)) is ‘held back’ or delayed by 250 samples in order to be synchronized with the audio data associated with the timestamp of 3750 (received from participant device 704 (Bob)), as shown in FIG. 7C. The synchronized audio data can then be processed (e.g., mixing the audio data, selecting a stream for playback, etc.), as generally shown at 742, and the result audio data stream can be sent to participant devices of the conference call, as generally shown at 744.

Different variations can be envisioned for including an offset timestamp of RTP packets (audio data frames) sent to a conference server depending on implementation. For example, in one embodiment, in addition to an RTP timestamp provided for each packet, a timestamp offset can be added in an extension header of each packet, starting from a first offset since detection of a non-ultrasound sync event and increasing by 960 (assuming a 48 kHz sampling rate) for each successive RTP packet sent to the conference server.

In another embodiment, a participant device can encode a particular timestep offset in a first RTP packet from a given detected non-ultrasound sync event, but not include another timestamp offset in subsequent RTP packets until another non-ultrasound sync event is detected by the participant device. In this embodiment, the conference server can incrementally add a timestamp offset of 960 (assuming a 48 kHz sampling rate) to each RTP packet received from the participant device until a new RTP packet containing a new timestamp offset is received from the participant device. In still another embodiment, a participant device may record/store a corresponding RTP timestamp for the time at which a given non-ultrasound sync event is detected and include the RTP timestamp for the detected event as synchronization information for RTP packets sent to the conference server such hat the conference server can determine the timestamp offset for each received RTP packet by calculating a difference between the RTP timestamp of the packet and the RTP timestamp of the detected event included in the packet. Thus, various alternatives can be envisioned for encoding a timestamp value (or indication thereof) in RTP packets sent to a conference server.

With regard to detection of a given non-ultrasound sync event, characteristics of the non-ultrasound sound waveform to be broadcast during a conference call can be optimized based on one or more criteria. For example, for the non-ultrasound sound waveform to be detected effectively and not be too invasive, for example, to be inaudible or imperceptible to participants during a conference call, the sound waveform characteristics may be generated such that it is to be a wide-band waveform that has been perceptually filtered.

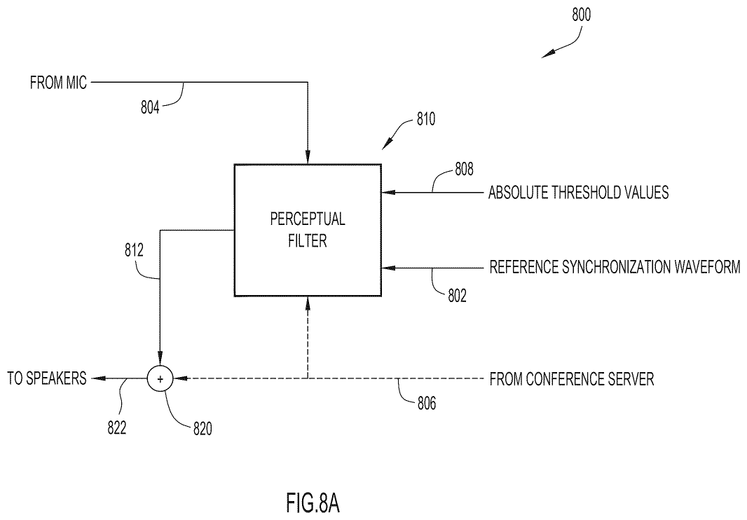

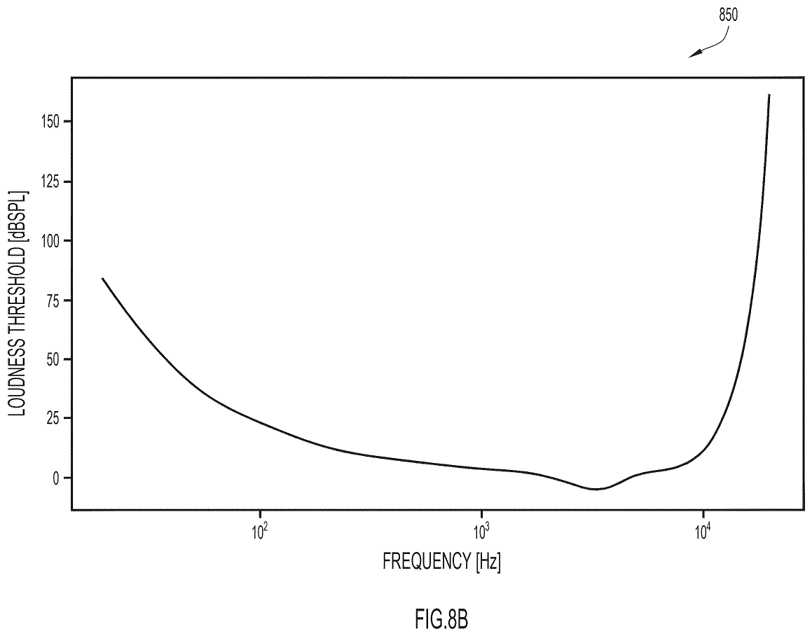

As shown in FIG. 8A, FIG. 8A is a diagram 800 illustrating various example details for a perceptual masking process that can be used by a synchronization source (e.g., a participant device or a non-participant device/room device) to generate a synchronization sound waveform for use with the non-ultrasound approach for synchronizing audio streams of multiple participant devices in proximity to one another during a conference call, according to an example embodiment.

As shown in FIG. 8A, a perceptual filter 810 can be applied to various audio data captured/received by a leader participant device, such as a reference synchronization waveform 802, sound captured from the microphone of the participant device, as shown at 804, playback audio received from the conference server, as shown at 806, and one or more threshold values 808, which may provide static limits or bounds for the perceptual filtering based on limits of human auditory systems. This may be similar to the characteristics of encoded audio signals used for digital steganography.

A sound output signal generated from the perceptual filter, as shown at 812, may be the non-ultrasound synchronization signal that is to be broadcast by the leader device, after it is mixed (as shown at 820) with any audio received from the conference server (806) in order to generate/emit the playback audio including periodic broadcasts of the non-ultrasound sync signal, as shown at 822. The perceptual filtering may facilitate adjusting an amplitude and/or frequency range for the non-ultrasound synchronization sound waveform.

The sound obtained from the microphone of the participant device (804) can be used to adjust the filter to account for temporal masking, which can improve performance of the filtering when there is near-end speech or noise captured by the microphone. For embodiments in which the synchronization source is a participant device for a conference call, the playback audio received from the conference server (806) can be used to adjust the filtering to account for simultaneous masking such that the power or amplitude of the non-ultrasound sync waveform (754, as shown in FIG. 7B) can be increased in critical bands to increase detectability of the non-ultrasound sync waveform without making the sound waveform/signal audible and also to avoid issues due to far end speech or noise. When a ‘masking signal’ is present at a given frequency, the critical band is a frequency band around the frequency of that masking signal where other frequencies are not heard, or masked.

With regard to avoiding issues due to far end speech or noise, far end speech can make detection of the sync signal harder, but such speech can also be used for the perceptual masking process in order to make the sync signal louder (at least in the same frequency regions as the ones where the far end speech is present) without being made audible. This can help to counterbalance the detection of a sync event that would otherwise be more difficult without such masking. The same masking can also be used near end speech, except the masking will be less strong because the sound picked up by the microphone is heard before the synch signal is played, making it less effective (e.g., temporal masking tapers down in 100˜200 ms).

It is noted that when the synchronization source is a non-participant device/room device, the audio from the conference server (806) may not be used on the perceptual masking process.

FIG. 8B is a schematic diagram 850 illustrating example details for a loudness threshold that can be used to design a perceptual filter for use with the perceptual masking process of FIG. 8A, according to an example embodiment.

The diagram 850 represents a model of the capability of the hearing human auditory system with the X-axis indicating a range of frequencies (in Hz) and the Y-axis indicating loudness thresholds in decibels Sound Pressure Level (dBSPL). Generally, for the diagram, the lower the curve, the more audible the frequency. Instead of using a ‘white noise’ like signal as the non-ultrasound sync signal, with a constant (as a function of frequency) power spectral density function, the sync signal can be shaped to ensure that it has a power spectral density that follows the shape of the loudness threshold shown in FIG. 8B. For the same power level (and detectability), this makes the sync signal less audible.

In some embodiments, simultaneous and temporal masking can further ‘raise’ the audibility threshold line for some frequencies so that the power of the sync signal can be further raised, making the sync signal more detectable without making it more audible.

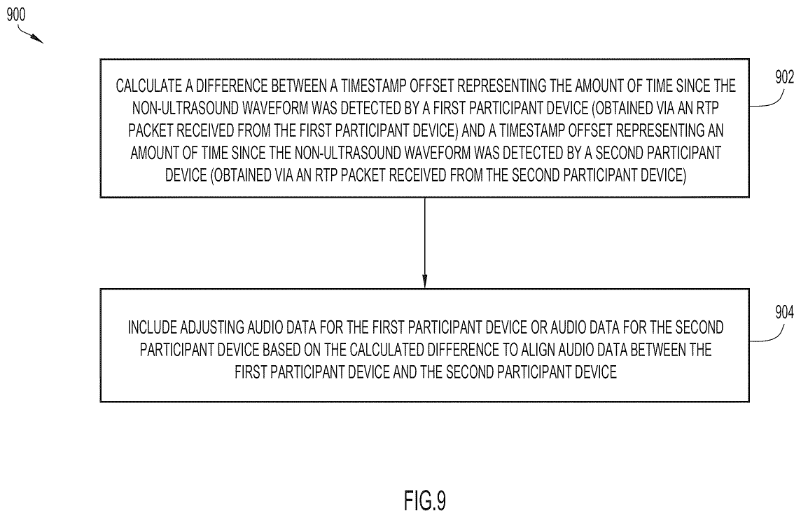

Referring to FIG. 9, FIG. 9 is a flow chart depicting a method 900 according to an example embodiment. In at least one embodiment, method 600 may be performed by a conference server, such as conference server 116 or conference server 706, in order to synchronize audio streams received from multiple participant devices containing various synchronization information that can be provided by the participant devices under the non-ultrasound sync approach.

As shown at 902, the method includes calculating a difference between a timestamp offset representing the amount of time since the non-ultrasound waveform was detected by a first participant device (obtained via an RTP packet received from the leader device) and a timestamp offset representing an amount of time since the non-ultrasound waveform was detected by a second participant device (e.g., obtained via an RTP packet received from the second participant device).

As shown at 904, the method may include adjusting audio data for the leader device or audio data for the first participant device (e.g., delay data for one of the streams) based on the calculated difference to align audio data between the first participant device and the second participant device.

Accordingly, the non-ultrasound synchronization approach may take advantage of steganographic techniques so that it can be used when other synchronization methods are either not available or may not be sufficiently accurate. Because the synchronization sound signal is in the same audio frequency range as speech captured during a conference call, there is no additional hardware requirement on the receiving device. In addition, because the microphone will pick up the synchronization sound signal in the same way as the near end speech, there is no need for further time alignment due to propagation across the device driver stack, as may be incurred with other types of broadcast synchronization signals/hardware.

It is noted that there may be some uncertainty with the approaches discussed herein, as the distance between a speaker and each microphone will not necessarily be the same as the distance between the synchronization source and each microphone. Yet, under an assumption of participant devices (e.g., laptops) being no further away from each other than 3 m, the timestamp offset will be less than 10 ms (or potentially even somewhat more than 3 m/10 ms), which would be acceptable.

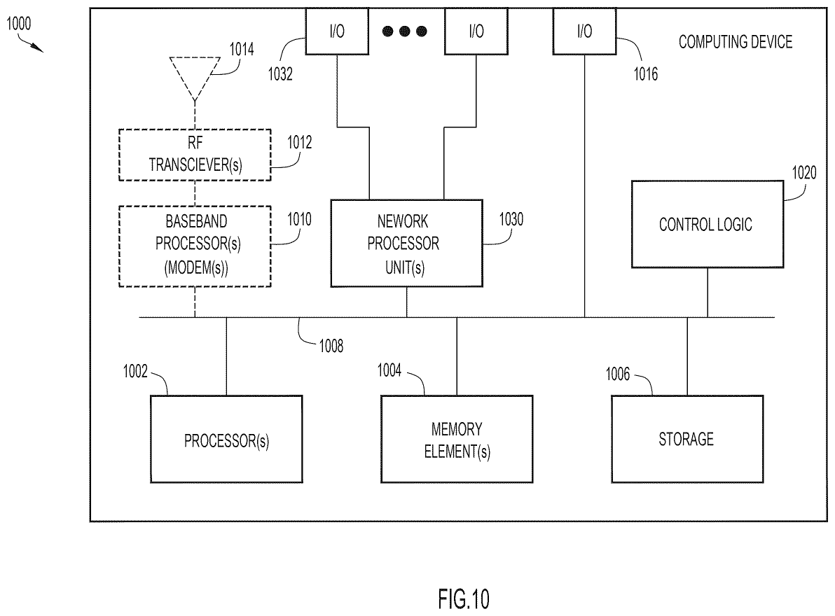

Referring to FIG. 10, FIG. 10 illustrates a hardware block diagram of a computing device 1000 that may perform functions associated with operations discussed herein in connection with the techniques described for embodiments herein. In various embodiments, a computing device or apparatus, such as computing device 1000 or any combination of computing devices 1000, may be configured as any entity/entities in order to perform operations of the various techniques discussed for embodiments herein, such as any elements, functions, etc. discussed for embodiments herein (e.g., a conference server, a participant device, etc.).

In at least one embodiment, the computing device 1000 may be any apparatus that may include one or more processor(s) 1002, one or more memory element(s) 1004, storage 1006, a bus 1008, one or more network processor unit(s) 1030 interconnected with one or more network input/output (I/O) interface(s) 1032, one or more I/O interface(s) 1016, and control logic 1020. In various embodiments, instructions associated with logic for computing device 1000 can overlap in any manner and are not limited to the specific allocation of instructions and/or operations described herein.

For embodiments in which computing device 1000 may be implemented as any device capable of wireless communications, computing device 1000 may further include at least one baseband processor or modem 1010, one or more radio RF transceiver(s) 1012 (e.g., any combination of RF receiver(s) and RF transmitter(s)), one or more antenna(s) or antenna array(s) 1014.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with memory element(s) 1004 (or vice versa) or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 6030 may enable communication between computing device 1000 and other systems, entities, etc., via network I/O interface(s) 1032 (wired and/or wireless) to facilitate operations discussed for various embodiments described herein. In various embodiments, network processor unit(s) 1030 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1032 can be configured as one or more Ethernet port(s), Fibre Channel ports, any other I/O port(s), and/or antenna(s)/antenna array(s) now known or hereafter developed. Thus, the network processor unit(s) 1030 and/or network I/O interface(s) 1032 may include suitable interfaces for receiving, transmitting, and/or otherwise communicating data and/or information (wired and/or wirelessly) in a network environment.

I/O interface(s) 1016 allow for input and output of data and/or information with other entities that may be connected to computing device 1000. For example, I/O interface(s) 1016 may provide a connection to external and/or internal devices such as a keyboard, keypad, a touch screen, a microphone, a speaker (e.g., a loudspeaker), and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 1000 is implemented as a wireless device or any apparatus capable of wireless communications, the RF transceiver(s) 1012 may perform RF emission/transmission and RF reception of wireless signals via antenna(s)/antenna array(s) 1014, and the baseband processor or modem 1010 performs baseband modulation and demodulation, etc. associated with such signals to enable wireless communications for computing device 1000.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include obtaining, by an aggregating node, each of an audio data stream from each of a plurality of participant devices that are proximate to each other within a conference space for a conference session in which each audio data stream obtained from each participant device comprises audio data and synchronization information, wherein the synchronization information is based on a synchronization sound broadcast during the conference session and received by each of the plurality of participant devices; and synchronizing, by the conference server, the audio data of each audio data stream based, at least in part, on the synchronization information included in each audio stream obtained from each of the plurality of participant devices.

In one instance, one participant device of the plurality of participant devices is selected to be a leader device for the conference session and other participant devices of the plurality of participant devices are follower devices for the conference session, and wherein the leader device broadcasts the synchronization sound and receives the synchronization sound and each of the follower devices receives the synchronization sound.

In one instance, the synchronization sound is an ultrasound token that comprises, for each of a plurality of broadcasts of the ultrasound token, a sequence number that increments for each broadcast. In one instance, the ultrasound token further comprises an Internet Protocol (IP) address set to zero.

In one instance, each audio data stream obtained from each of the plurality of participant devices is a plurality of Real-time Transport Protocol (RTP) packets obtained from each of the plurality of participant devices.

In one instance, at least one RTP packet obtained from the leader device includes an RTP timestamp and the synchronization information includes a particular sequence number of a particular ultrasound token detected by the leader device and an indication of a number of milliseconds since the particular ultrasound token was detected by the leader device; and at least one RTP packet obtained from at least one follower device includes an RTP timestamp and the synchronization information includes the particular sequence number of the particular ultrasound token detected by the at least one follower device and an indication of a number of milliseconds since the particular ultrasound token was detected by the at least one follower device.

In one instance, the synchronizing includes: calculating, based on the synchronization information and the RTP timestamp obtained from the leader device, an ultrasound detection timestamp for the leader device to for a time at which the leader device detected the particular ultrasound token having the particular sequence number; calculating, based on the synchronization information and the RTP timestamp obtained from the at least one follower device, an ultrasound detection timestamp for the at least one follower device for a time at which the at least one follower device detected the particular ultrasound token having the particular sequence number; calculating a timestamp difference between the ultrasound detection timestamp for the leader device and the ultrasound detection timestamp for the at least one follower device; and updating the RTP timestamp for the at least one follower device based on the timestamp difference in order to synchronize audio data for the at least one RTP packet obtained from the at least one follower device and audio data for the at least one RTP packet obtained from the leader device to a common wall clock. In one instance, the common wall clock is the leader's RTP timestamp.

In one instance, the synchronizing is performed for each of a plurality of RTP packets obtained from each of the leader device and the at least one follower device for a plurality of particular ultrasound token broadcasts, wherein the synchronizing includes normalizing the timestamp difference based on an averaging process or a histogram process performed for the plurality of RTP packets.

In one instance, the synchronization sound is a non-ultrasound sound waveform that is broadcast by a broadcasting device proximate to the plurality of participant devices and wherein each audio data stream obtained from each of the plurality of participant devices is a plurality of Real-time Transport Protocol (RTP) packets obtained from each of the plurality of participant devices comprising audio data.

In at least one instance, at least one of an amplitude or a frequency range of the non-ultrasound sound waveform are generated based on a perceptual masking process performed using a reference synchronization sound waveform, sound captured by a microphone of the broadcasting device, and one or more threshold values. In at least one instance, the broadcasting device is one of the plurality of participant devices and the perceptual masking process is further performed using playback audio received from the aggregating node.

In at least one instance, at least one RTP packet obtained from a first participant device of the plurality of participant devices includes an RTP timestamp and the synchronization information includes a timestamp offset representing an amount of time since the non-ultrasound sound waveform was detected by the first participant device; and at least one RTP packet obtained from a second participant device includes an RTP timestamp and the synchronization information includes a timestamp offset representing an amount of time since the non-ultrasound sound waveform was detected by the second participant device.

In at least one instance, the first participant device detects the non-ultrasound waveform at a particular time by performing a cross-correlation between sound detected via a microphone of the first participant device and a reference waveform corresponding to the non-ultrasound sound waveform; and the second participant device detects the non-ultrasound sound waveform at a particular time by performing a cross-correlation between sound detected via a microphone of the second participant device and a reference waveform corresponding to the non-ultrasound sound waveform.

In at least one instance, calculating a difference between the timestamp offset representing the amount of time since the non-ultrasound sound waveform was detected by the first participant device and the timestamp offset representing an amount of time since the non-ultrasound sound waveform was detected by the second participant device; and adjusting audio data for the first participant device or audio data for the second participant device based on the calculated difference to align audio data between the first participant device and the second participant device.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IOT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by an aggregating node, each of an audio data stream from each of a plurality of participant devices that are proximate to each other within a conference space for a conference session in which each audio data stream obtained from each participant device comprises audio data and synchronization information, wherein the synchronization information is based on a synchronization sound broadcast during the conference session and received by each of the plurality of participant devices; and
synchronizing, by the aggregating node, the audio data of each audio data stream based, at least in part, on the synchronization information included in each audio stream obtained from each of the plurality of participant devices.

2. The method of claim 1, wherein one participant device of the plurality of participant devices is selected to be a leader device for the conference session and other participant devices of the plurality of participant devices are follower devices for the conference session, and wherein the leader device broadcasts the synchronization sound and receives the synchronization sound and each of the follower devices receives the synchronization sound.

3. The method of claim of claim 2, wherein the synchronization sound is an ultrasound token that comprises, for each of a plurality of broadcasts of the ultrasound token, a sequence number that increments for each broadcast.

4. The method of claim 3, wherein the ultrasound token further comprises an Internet Protocol (IP) address set to zero.

5. The method of claim 3, wherein each audio data stream obtained from each of the plurality of participant devices is a plurality of Real-time Transport Protocol (RTP) packets obtained from each of the plurality of participant devices.

6. The method of claim 5, wherein:
at least one RTP packet obtained from the leader device includes an RTP timestamp and the synchronization information includes a particular sequence number of a particular ultrasound token detected by the leader device and an indication of a number of milliseconds since the particular ultrasound token was detected by the leader device; and
at least one RTP packet obtained from at least one follower device includes an RTP timestamp and the synchronization information includes the particular sequence number of the particular ultrasound token detected by the at least one follower device and an indication of a number of milliseconds since the particular ultrasound token was detected by the at least one follower device.

7. The method of claim 6, wherein the synchronizing includes:
calculating, based on the synchronization information and the RTP timestamp obtained from the leader device, an ultrasound detection timestamp for the leader device to for a time at which the leader device detected the particular ultrasound token having the particular sequence number;
calculating, based on the synchronization information and the RTP timestamp obtained from the at least one follower device, an ultrasound detection timestamp for the at least one follower device for a time at which the at least one follower device detected the particular ultrasound token having the particular sequence number;
calculating a timestamp difference between the ultrasound detection timestamp for the leader device and the ultrasound detection timestamp for the at least one follower device; and
updating the RTP timestamp for the at least one follower device based on the timestamp difference in order to synchronize audio data for the at least one RTP packet obtained from the at least one follower device and audio data for the at least one RTP packet obtained from the leader device to a common wall clock.

8. The method of claim 7, wherein the synchronizing is performed for each of a plurality of RTP packets obtained from each of the leader device and the at least one follower device for a plurality of particular ultrasound token broadcasts, wherein the synchronizing includes normalizing the timestamp difference based on an averaging process or a histogram process performed for the plurality of RTP packets.

9. The method of claim 1, wherein the synchronization sound is a non-ultrasound sound waveform that is broadcast by a broadcasting device proximate to the plurality of participant devices and wherein each audio data stream obtained from each of the plurality of participant devices is a plurality of Real-time Transport Protocol (RTP) packets obtained from each of the plurality of participant devices comprising audio data.

10. The method of claim 9, wherein at least one of an amplitude or a frequency range of the non-ultrasound sound waveform are generated based on a perceptual masking process performed using a reference synchronization sound waveform, sound captured by a microphone of the broadcasting device, and one or more threshold values.

11. The method of claim 10, wherein the broadcasting device is one of the plurality of participant devices and the perceptual masking process is further performed using playback audio received from the aggregating node.

12. The method of claim 9, wherein:
at least one RTP packet obtained from a first participant device of the plurality of participant devices includes an RTP timestamp and the synchronization information includes a timestamp offset representing an amount of time since the non-ultrasound sound waveform was detected by the first participant device; and
at least one RTP packet obtained from a second participant device includes an RTP timestamp and the synchronization information includes a timestamp offset representing an amount of time since the non-ultrasound sound waveform was detected by the second participant device.

13. The method of claim 12, wherein:
the first participant device detects the non-ultrasound waveform at a particular time by performing a cross-correlation between sound detected via a microphone of the first participant device and a reference waveform corresponding to the non-ultrasound sound waveform; and
the second participant device detects the non-ultrasound sound waveform at a particular time by performing a cross-correlation between sound detected via a microphone of the second participant device and a reference waveform corresponding to the non-ultrasound sound waveform.

14. The method of claim 13, wherein the synchronizing includes:
calculating a difference between the timestamp offset representing the amount of time since the non-ultrasound sound waveform was detected by the first participant device and the timestamp offset representing an amount of time since the non-ultrasound sound waveform was detected by the second participant device; and
adjusting audio data for the first participant device or audio data for the second participant device based on the calculated difference to align audio data between the first participant device and the second participant device.

15. One or more non-transitory computer readable storage media encoded with instructions that, when executed by a processor, cause the processor to perform operations, comprising:
obtaining, by an aggregating node, each of an audio data stream from each of a plurality of participant devices that are proximate to each other within a conference space for a conference session in which each audio data stream obtained from each participant device comprises audio data and synchronization information, wherein the synchronization information is based on a synchronization sound broadcast during the conference session and received by each of the plurality of participant devices; and
synchronizing, by the aggregating node, the audio data of each audio data stream based, at least in part, on the synchronization information included in each audio stream obtained from each of the plurality of participant devices.

16. The media of claim 15, wherein one participant device of the plurality of participant devices is selected to be a leader device for the conference session and other participant devices of the plurality of participant devices are follower devices for the conference session, and wherein the leader device broadcasts the synchronization sound and receives the synchronization sound and each of the follower devices receives the synchronization sound, and wherein the synchronization sound is an ultrasound token that comprises, for each of a plurality of broadcasts of the ultrasound token, a sequence number that increments for each broadcast.

17. The media of claim 15, wherein the synchronization sound is a non-ultrasound sound waveform that is broadcast by a broadcasting device proximate to the plurality of participant devices.

18. A system comprising:
at least one memory element for storing data; and
at least one processor for executing instructions associated with the data, wherein executing the instructions causes the system to perform operations, comprising:
obtaining, by an aggregating node, each of an audio data stream from each of a plurality of participant devices that are proximate to each other within a conference space for a conference session in which each audio data stream obtained from each participant device comprises audio data and synchronization information, wherein the synchronization information is based on a synchronization sound broadcast during the conference session and received by each of the plurality of participant devices; and
synchronizing, by the aggregating node, the audio data of each audio data stream based, at least in part, on the synchronization information included in each audio stream obtained from each of the plurality of participant devices.

19. The system of claim 18, wherein one participant device of the plurality of participant devices is selected to be a leader device for the conference session and other participant devices of the plurality of participant devices are follower devices for the conference session, and wherein the leader device broadcasts the synchronization sound and receives the synchronization sound and each of the follower devices receives the synchronization sound, and wherein the synchronization sound is an ultrasound token that comprises, for each of a plurality of broadcasts of the ultrasound token, a sequence number that increments for each broadcast.

20. The system of claim 18, wherein the synchronization sound is a non-ultrasound sound waveform that is broadcast by a broadcasting device proximate to the plurality of participant devices.
